(19) United States
(12) Patent Application Publication
(10) Pub. No.: US 2023/0287148 A1
(43) Pub. Date: Sep. 14, 2023

(54) POLY ALPHA-1,6-GLUCAN ESTERS AND COMPOSITIONS COMPRISING SAME

(71) Applicant: NUTRITION & BIOSCIENCES USA 4, INC., Rochester, NY (US)

(72) Inventors: ZHENGZHENG HUANG, HOCKESSIN, DE (US); DOUGLAS J. ADELMAN, WILMINGTON, DE (US); JEAN-POL BOUTIQUE, STROMBEEK-BEVER (BE); RUTH CHILTON, NEWCASTLE UPON TYNE (GB); NEIL THOMAS FAIRWEATHER, Liberty Township, OH (US); KRISTI LYNN FLITER, CINCINNATI, OH (US); HELEN S.M. LU, WALLINGFORD, PA (US); MARK ROBERT SIVIK, CINCINNATI, OH (US); GANG SI, NEWCASTLE UPON TYNE (GB); DAVID GOOD, CINCINNATI, OH (US)

(21) Appl. No.: 18/008,213

(22) PCT Filed: Jun. 9, 2021
(86) PCT No.: PCT/US2021/036536

§ 371 Date: Dec. 5, 2022

Related U.S. Application Data
(60) Provisional application No. 63/037,184, filed on Jun. 10, 2020.

(51) Int. Cl. C08B 37/00; C11D 3/22

(52) U.S. Cl. CPC C08B 37/0009; C11D 3/226

(57) ABSTRACT

The disclosure relates to poly alpha-1,6-glucan ester compounds comprising poly alpha-1,6-glucan substituted with at least one ester group as defined herein and having a degree of substitution of about 0.001 to about 3.0. The poly alpha-1,6-glucan comprises a backbone of glucose monomer units wherein greater than or equal to 40% of the glucose monomer units are linked via alpha-1,6 glycosidic linkages, and optionally at least 5% of the backbone glucose monomer units have branches via alpha-1,2 and/or alpha-1,3 glycosidic linkages. Compositions comprising a poly alpha-1,6-glucan ester compound can be useful in various applications.

This application claims the benefit of U.S. Provisional Appl. No. 63/037,184 (filed Jun. 10, 2020), which is incorporated herein by reference in its entirety.

### FIELD OF THE DISCLOSURE

The present disclosure is directed towards poly alpha-1,6-glucan ester compounds comprising poly alpha-1,6-glucan substituted with at least one ester group. The poly alpha-1,6-glucan comprises a backbone of glucose monomer units wherein greater than or equal to 40% of the glucose monomer units are linked via alpha-1,6 glycosidic linkages, and optionally at least 5% of the backbone glucose monomer units have branches via alpha-1,2 and/or alpha-1,3 glycosidic linkages.

### BACKGROUND

Driven by a desire to find new structural polysaccharides using enzymatic syntheses or genetic engineering of microorganisms, researchers have discovered oligosaccharides and polysaccharides that are biodegradable and can be made economically from renewably-sourced feedstocks. Hydrophobicallly modified polysaccharides derived from enzymatic syntheses or genetic engineering of microorganisms can find applications as viscosity modifiers, emulsifiers, film formers in liquid formulations such as laundry, fabric care, cleaning, and personal care compositions.

Modern detergent compositions, including laundry, fabric, dishwashing or other cleaning compositions, comprise common detergent ingredients such as anionic, nonionic, cationic, amphoteric, zwitterionic, and/or semi-polar surfactants, as well as enzymes such as proteases, cellulases, lipases, amylases, and/or peroxidases. Laundry detergent and/or fabric care compositions may further comprise various detergent ingredients having one or more purposes in obtaining fabrics which are not only clean, fresh, and sanitized, but also have retained appearance and integrity. Therefore, benefit agents such as perfumes, hygiene agents, insect control agents, bleaching agents, fabric softeners, dye fixatives, soil release agents, and fabric brightening agents have been incorporated into laundry detergent and/or fabric care compositions. In using such detergent components, it is important that some of these compounds deposit on the fabrics so as to be effective during or after the laundering and/or fabric care process.

There is a continuing need for new materials which can be used in aqueous applications such as fabric care, for example as anti-deposition and/or anti-graying agents and/or whiteness benefit agents in laundry detergents, and in home and personal care applications. There remains a need for such materials which can be made from renewable resources and are biodegradable.

### SUMMARY

Disclosed herein are poly alpha-1,6-glucan ester compounds comprising:
(i) poly alpha-1,6-glucan substituted with at least one ester group selected from an aryl ester group, a first ester group comprising a first acyl group —CO—R″ wherein R″ comprises a chain of 1 to 24 carbon atoms, a second ester group comprising a second acyl group —CO—Cₓ—COOH, wherein —Cₓ— comprises a chain of 2 to 24 carbon atoms, or a combination thereof;
(ii) a weight average degree of polymerization of at least 5; and
(iii) a degree of substitution of about 0.001 to about 3.0;
wherein the poly alpha-1,6-glucan comprises a backbone of glucose monomer units, and wherein greater than or equal to 40% of the glucose monomer units are linked via alpha-1,6 glycosidic linkages.

In one embodiment, at least 5% of the backbone glucose monomer units have branches via alpha-1,2 and/or alpha-1,3 glycosidic linkages. In one embodiment, the degree of substitution is about 0.01 to about 1.5. In one embodiment, the degree of substitution is about 0.01 to about 0.6. In one embodiment, the degree of substitution is about 0.01 to about 0.2. In one embodiment, the poly alpha-1,6-glucan ester compound has a weight average degree of polymerization in the range of from about 5 to about 4000. In one embodiment, the poly alpha-1,6-glucan ester compound has a biodegradability as determined by the Carbon Dioxide Evolution Test Method of at least 10% after 90 days of testing.

In one embodiment, at least one ester group is an aryl ester group, a first ester group comprising a first acyl group, or a combination thereof. In one embodiment, the aryl ester group comprises a benzoyl group or a benzoyl group substituted with at least one halogen, alkyl, halogenated alkyl, ether, cyano, or aldehyde group, or a combination thereof. In one embodiment, the first acyl group is an acetyl or a propionyl group. In one embodiment, the aryl ester group is a benzoyl group and the first acyl group is an acetyl or a propionyl group. In one embodiment, at least one ester group is a first ester group comprising a first acyl group. In one embodiment, at least one ester group is a second ester group comprising a second acyl group —CO—Cₓ—COOH wherein —Cₓ— comprises a chain of 2 to 24 carbon atoms. In one embodiment, —Cₓ— of the second acyl group further comprises only CH₂ groups. In one embodiment, —Cₓ— of the second acyl group further comprises i) at least one double-bond in the carbon atom chain, and/or ii) at least one branch comprising an organic group. In one embodiment, at least one ester group is a first ester group comprising a first acyl group —CO—R″ and at least one ester group is a second ester group comprising a second acyl group —CO—Cₓ—COOH.

Also disclosed herein are compositions comprising a poly alpha-1,6-glucan ester compound as disclosed herein. Further disclosed herein are a personal care product, a home care product, an industrial product, and a fabric care product comprising a poly alpha-1,6-glucan ester compound as disclosed herein, or comprising a composition containing a poly alpha-1,6-glucan ester compound as disclosed herein.

In one embodiment, the composition is in the form of a liquid, a gel, a powder, a hydrocolloid, an aqueous solution, a granule, a tablet, a capsule, a bead or pastille, a single compartment sachet, a pad, a multi-compartment sachet, a single compartment pouch, or a multi-compartment pouch.

In one embodiment, the composition further comprises at least one of a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer-inhibiting agent, a chelating agent, a hueing dye, a calcium cation, a magnesium cation, a visual signaling ingredient, an anti-foam, a structurant, a thickener, an anti-caking agent, a starch, sand, a gelling agent, or a combination thereof.

In one embodiment, the enzyme is a cellulase, a protease, a lipase, an amylase, or a combination thereof. In one embodiment, the enzyme is a cellulase. In one embodiment, the enzyme is a protease. In one embodiment, the enzyme is an amylase.

Also disclosed herein is a method for treating a substrate, the method comprising the steps:
(a) providing a composition comprising a poly alpha-1,6-glucan ester compound as disclosed herein;
(b) contacting the substrate with the composition; and
(c) optionally rinsing the substrate;
wherein the substrate is a textile, a fabric, carpet, upholstery, apparel, or a surface.

### DETAILED DESCRIPTION

The disclosures of all cited patent and non-patent literature are incorporated herein by reference in their entirety.

As used herein, the term “embodiment” or “disclosure” is not meant to be limiting, but applies generally to any of the embodiments defined in the claims or described herein. These terms are used interchangeably herein.

In this disclosure, a number of terms and abbreviations are used. The following definitions apply unless specifically stated otherwise.

The articles “a”, “an”, and “the” preceding an element or component are intended to be nonrestrictive regarding the number of instances (i.e. occurrences) of the element or component. These articles should be read to include one or at least one, and the singular word form of the element or component also includes the plural unless the number is obviously meant to be singular.

The term “comprising” means the presence of the stated features, integers, steps, or components as referred to in the claims, but that it does not preclude the presence or addition of one or more other features, integers, steps, components, or groups thereof. The term “comprising” is intended to include embodiments encompassed by the terms “consisting essentially of” and “consisting of”. Similarly, the term “consisting essentially of” is intended to include embodiments encompassed by the term “consisting of”.

Where present, all ranges are inclusive and combinable. For example, when a range of “1 to 5” is recited, the recited range should be construed as including ranges “1 to 4”, “1 to 3”, 1-2”, “1-2 and 4-5”, “1-3 and 5”, and the like.

It is intended that every maximum numerical limitation given throughout this Specification includes every lower numerical limitation, as if such lower numerical limitations were expressly written herein. Every minimum numerical limitation given throughout this Specification will include every higher numerical limitation, as if such higher numerical limitations were expressly written herein. Every numerical range given throughout this Specification will include every narrower numerical range that falls within such broader numerical range, as if such narrower numerical ranges were all expressly written herein.

The use of numerical values in the various ranges specified in this application, unless expressly indicated otherwise, are stated as approximations as though the minimum and maximum values within the stated ranges were both proceeded by the word “about”. In this manner, slight variations above and below the stated ranges can be used to achieve substantially the same results as values within the ranges. Also, the disclosure of these ranges is intended as a continuous range including each and every value between the minimum and maximum values.

The features and advantages of the present disclosure will be more readily understood, by those of ordinary skill in the art from reading the following detailed description. It is to be appreciated that certain features of the disclosure, which are, for clarity, described above and below in the context of separate embodiments, may also be provided in combination in a single element. Conversely, various features of the disclosure that are, for brevity, described in the context of a single embodiment, may also be provided separately or in any sub-combination. In addition, references to the singular may also include the plural (for example, “a” and “an” may refer to one or more) unless the context specifically states otherwise.

As used herein:

The term “polysaccharide” means a polymeric carbohydrate molecule composed of long chains of monosaccharide units bound together by glycosidic linkages and on hydrolysis give the constituent monosaccharides or oligosaccharides.

The terms “poly alpha-1,6-glucan”, “alpha-1,6-glucan”, “dextran”, “dextran polymer” and the like herein refer to an alpha-glucan comprising at least 40% alpha-1,6 glycosidic linkages.

The terms “percent by weight”, “weight percentage (wt%)” and “weight-weight percentage (% w/w)” are used interchangeably herein. Percent by weight refers to the percentage of a material on a mass basis as it is comprised in a composition, mixture or solution.

The phrase “water insoluble” means that less than 1 gram of the polysaccharide or polysaccharide derivative dissolves in 1000 milliliters of water at 23° C.

The term “water soluble” means that the polysaccharide or polysaccharide derivative is soluble at 1 % by weight or higher in pH 7 water at 25° C. The percentage by weight is based on the total weight of the polysaccharide soluble in water, for example, 1 gram of polysaccharide in 100 grams of water.

The term “hydrophobic” refers to a molecule or substituent which is nonpolar and has little or no affinity for water, and which tends to repel water.

The term “molar substitution” (M.S.) as used herein refers to the moles of an organic group per monomeric unit of the polysaccharide or the derivative thereof. It is noted that the molar substitution value for a poly alpha-1,6-glucan derivative, for example, may have a very high upper limit, for example in the hundreds or even thousands. For example, if the organic group is a hydroxyl-containing alkyl group, via the addition of ethylene oxide to one of the hydroxyl groups of the poly alpha-1,6-glucan, then the so-formed hydroxyl group from the ethylene oxide can then be further etherified to form a polyether.

The “molecular weight” of a polysaccharide or polysaccharide derivative can be represented as statistically averaged molecular mass distribution, i.e. as number-average molecular weight (Mₙ) or as weight-average molecular weight (M_{w}), both of which are generally given in units of Daltons (Da), i.e. in grams/mole. Alternatively, molecular weight can be represented as DPw (weight average degree of polymerization), or DPn (number average degree of polymerization). Various means are known in the art for calculating these molecular weights from techniques such as high-pressure liquid chromatography (HPLC), size exclusion chromatography (SEC), gel permeation chromatography (GPC), and gel filtration chromatography (GFC).

As used herein, “weight average molecular weight” or “M_{w}” is calculated as M_{w} = ΣNᵢMᵢ² / ΣNᵢMᵢ; where Mᵢ is the molecular weight of an individual chain i and Nᵢ is the number of chains of that molecular weight. In addition to using SEC, the weight average molecular weight can be determined by other techniques such as static light scattering, mass spectrometry especially MALDI-TOF (matrix-assisted laser desorption/ionization time-of-flight), small angle X-ray or neutron scattering, and ultracentrifugation.

As used herein, “number average molecular weight” or “Mₙ” refers to the statistical average molecular weight of all the polymer chains in a sample. The number average molecular weight is calculated as Mₙ = ΣNᵢMᵢ / ΣNᵢ where Mᵢ is the molecular weight of a chain i and Nᵢ is the number of chains of that molecular weight. In addition to using SEC, the number average molecular weight of a polymer can be determined by various colligative methods such as vapor pressure osmometry or end-group determination by spectroscopic methods such as proton NMR, FTIR, or UV-vis.

As used herein, number average degree of polymerization (DPn) and weight average degree of polymerization (DPw) are calculated from the corresponding average molecular weights Mw or Mn by dividing by the molar mass of one monomer unit M₁. In the case of unsubstituted glucan polymer, M₁ = 162. In the case of a substituted glucan polymer, M₁ = 162 + Mf × DoS, where M_{f} is the molar mass of the substituent group and DoS is the degree of substitution with respect to that substituent group (average number of substituted groups per one glucose unit).

Glucose carbon positions 1, 2, 3, 4, 5 and 6 as referred to herein are as known in the art and depicted in Structure I:

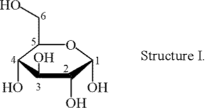

The terms “glycosidic linkage” and “glycosidic bond” are used interchangeably herein and refer to the type of covalent bond that joins a carbohydrate (sugar) molecule to another group such as another carbohydrate. The term “alpha-1,6-glucosidic linkage” as used herein refers to the covalent bond that joins alpha-D-glucose molecules to each other through carbons 1 and 6 on adjacent alpha-D-glucose rings. The term “alpha-1,3-glucosidic linkage” as used herein refers to the covalent bond that joins alpha-D-glucose molecules to each other through carbons 1 and 3 on adjacent alpha-D-glucose rings. The term “alpha-1,2-glucosidic linkage” as used herein refers to the covalent bond that joins alpha-D-glucose molecules to each other through carbons 1 and 2 on adjacent alpha-D-glucose rings. The term “alpha-1,4-glucosidic linkage” as used herein refers to the covalent bond that joins alpha-D-glucose molecules to each other through carbons 1 and 4 on adjacent alpha-D-glucose rings. Herein, “alpha-D-glucose” will be referred to as “glucose”.

The glycosidic linkage profile of a glucan, dextran, substituted glucan, or substituted dextran can be determined using any method known in the art. For example, a linkage profile can be determined using methods that use nuclear magnetic resonance (NMR) spectroscopy (e.g., ¹³C NMR or ¹H NMR). These and other methods that can be used are disclosed in Food Carbohydrates: Chemistry, Physical Properties, and Applications (S. W. Cui, Ed., Chapter 3, S. W. Cui, Structural Analysis of Polysaccharides, Taylor & Francis Group LLC, Boca Raton, FL, 2005), which is incorporated herein by reference.

The structure, molecular weight, and degree of substitution of a polysaccharide or polysaccharide derivative can be confirmed using various physiochemical analyses known in the art such as NMR spectroscopy and size exclusion chromatography (SEC).

The terms “household care product”, “home care product”, and like terms typically refer to products, goods and services relating to the treatment, cleaning, caring, and/or conditioning of a home and its contents, including but not limited to garments and fabrics. The foregoing includes, for example, chemicals, compositions, products, or combinations thereof having application in such care.

The term “personal care product” and like terms typically refer to products, goods and services relating to the treatment, cleaning, cleansing, caring, or conditioning of a person. The foregoing includes, for example, chemicals, compositions, products, or combinations thereof having application in such care.

The term “industrial product” and like terms typically refer to products, goods and services used in industrial settings, but typically not by individual consumers.

The present disclosure is directed to a poly alpha-1,6-glucan ester compound comprising:
(i) poly alpha-1,6-glucan substituted with at least one ester group selected from an aryl ester group, a first ester group comprising a first acyl group -CO-R″ wherein R″ comprises a chain of 1 to 24 carbon atoms, a second ester group comprising a second acyl group —CO—Cₓ—COOH, wherein —Cₓ— comprises a chain of 2 to 24 carbon atoms, or a combination thereof;
(ii) a weight average degree of polymerization of at least 5; and
(iii) a degree of substitution of about 0.001 to about 3.0;
wherein the poly alpha-1,6-glucan comprises a backbone of glucose monomer units wherein greater than or equal to 40% of the glucose monomer units are linked via alpha-1,6-glycosidic linkages, and optionally at least 5% of the backbone glucose monomer units have branches via alpha-1,2 and/or alpha-1,3 glycosidic linkages. Optionally, the poly alpha-1,6-glucan is (a) only substituted with one or more of the aryl ester group, the first ester group, or the second aryl group, or (b) not substituted with a hydrophilic group.

The poly alpha-1,6-glucan ester compounds disclosed herein comprise water-soluble poly alpha-1,6-glucan comprising a backbone of glucose monomer units wherein greater than or equal to 40% of the glucose monomer units are linked via alpha-1,6-glycosidic linkages, and optionally at least 5% of the backbone glucose monomer units have branches via alpha-1,2 and/or alpha-1,3-glycosidic linkages, the poly alpha-1,6-glucan being substituted (preferably randomly substituted) with ester groups on the polysaccharide backbone and/or on any branches which may be present, such that the poly alpha-1,6-glucan ester compound comprises, in some aspects, unsubstituted and substituted alpha-D-glucose rings. As used herein, the term “randomly substituted” means the substituents on the glucose rings in the randomly substituted polysaccharide occur in a non-repeating or random fashion. That is, the substitution on a substituted glucose ring may be the same or different [i.e. the substituents (which may be the same or different) on different atoms in the glucose rings in the polysaccharide] from the substitution on a second substituted glucose ring in the polysaccharide, such that the overall substitution on the polymer has no pattern. Further, the substituted glucose rings occur randomly within the polysaccharide (i.e., there is no pattern with the substituted and unsubstituted glucose rings within the polysaccharide).

In some embodiments, depending on reaction conditions and the specific substituent used to derivatize the poly alpha-1,6-glucan, the glucose monomers of the polymer backbone may be disproportionately substituted relative to the glucose monomers of any branches, including branches via alpha-1,2 and/or alpha-1,3 linkages, if present. In another embodiment, the glucose monomers of the branches, including branches via alpha-1,2 and/or alpha-1,3 linkages, if present, may be disproportionately substituted relative to the glucose monomers of the polymer backbone. In some embodiments, depending on reaction conditions and the specific substituent used, substitution of the poly alpha-1,6-glucan may occur in a block manner.

In some embodiments, depending on reaction conditions and the specific substituent used to derivatize the poly alpha-1,6-glucan, it is possible that the hydroxyl groups at certain glucose carbon positions may be disproportionately substituted. For example, in some embodiments, the hydroxyl at carbon position 2, 3, or 4 may be more substituted than the hydroxyls at other carbon positions.

The poly alpha-1,6-glucan ester compounds disclosed herein contain hydrophobic substituents and are of interest due to their solubility characteristics in water, and solutions containing surfactants, which can be varied by appropriate selection of substituents and the degree of substitution. Compositions comprising the poly alpha-1,6-glucan ester compounds can be useful in a wide range of applications, including laundry, cleaning, food, cosmetics, industrial, film, and paper production. Compositions comprising poly alpha-1,6-glucan ester compounds as disclosed herein and having solubility of 1 % by weight or higher in pH 7 water at 25° C. may be useful in aqueous based applications such as laundry, cleaning, coating, and personal care. Compositions comprising poly alpha-1,6-glucan ester compounds as disclosed herein and having solubility less than 1% by weight in pH 7 water at 25° C. may be useful for industrial, film, controlled release, and composite applications, for example.

There is increasing interest to develop biodegradable materials for the above mentioned applications. Compositions comprising poly alpha-1,6-glucan ester compounds may be sustainable materials in applications disclosed herein. Furthermore, biodegradable alpha-1,6-glucan derivatives are preferred over non-biodegradable materials from an environmental footprint perspective. Biodegradability of a material can be evaluated by methods known in the art, for example, or as disclosed in the Examples section herein below. In some embodiments, the poly alpha-1,6-glucan derivative has a biodegradability as determined by the Carbon Dioxide Evolution Test Method (OECD Guideline 301B) of about, or at least about, 5%, 10%, 15%, 20%, 25%, 30%, 35%, 40%, 45%, 50%, 55%, 60%, 65%, 70%, 75%, 80%, 85%, 90%, 5-80%, 5-90%, 40-70%, 50-70%, 60-70%, 40-75%, 50-75%, 60-75%, 70-75%, 40-80%, 50-80%, 60-80%, 70-80%, 40-85%, 50-85%, 60-85%, 70-85%, 40-90%, 50-90%, 60-90%, or 70-90%, or any value between 5% and 90%, after 30, 60, or 90 days of performing the test.

The poly alpha-1,6-glucan ester compounds disclosed herein can be comprised in a personal care product, pharmaceutical product, household product, or industrial product in an amount that provides a desired degree of one or more of the following physical properties to the product: thickening, freeze/thaw stability, lubricity, moisture retention and release, texture, consistency, shape retention, emulsification, binding, suspension, dispersion, and gelation, for example. Examples of a concentration or amount of a poly alpha-1,6-glucan ester compound as disclosed herein in a product, on a weight basis, can be about 0.1-3 wt%, 1-2 wt%, 1.5-2.5 wt%, 2.0 wt%, 0.1-4 wt%, 0.1-5 wt%, or 0.1-10 wt%, for example.

A household and/or industrial product herein can be in the form of drywall tape-joint compounds; mortars; grouts; cement plasters; spray plasters; cement stucco; adhesives; pastes; wall/ceiling texturizers; binders and processing aids for tape casting, extrusion forming, injection molding and ceramics; spray adherents and suspending/dispersing aids for pesticides, herbicides, and fertilizers; fabric care products such as fabric softeners and laundry detergents; hard surface cleaners; air fresheners; polymer emulsions; gels such as water-based gels; surfactant solutions; paints such as water-based paints; protective coatings; adhesives; sealants and caulks; inks such as water-based ink; metalworking fluids; emulsion-based metal cleaning fluids used in electroplating, phosphatizing, galvanizing and/or general metal cleaning operations; hydraulic fluids (e.g., those used for fracking in downhole operations); and aqueous mineral slurries, for example.

The terms “poly alpha-1,6-glucan” and “dextran” are used interchangeably herein. Dextrans represent a family of complex, branched alpha-glucans generally comprising chains of alpha-1,6-linked glucose monomers, with periodic side chains (branches) linked to the straight chains by alpha-1,3-linkage (loan et al., Macromolecules 33:5730-5739) and/or alpha-1,2-linkage. Production of dextran for producing a poly alpha-1,6-glucan derivative herein can be done, for example, through fermentation of sucrose with bacteria (e.g., Leuconostoc or Streptococcus species), where sucrose serves as the source of glucose for dextran polymerization (Naessens et al., J. Chem. Technol. Biotechnol. 80:845-860; Sarwat et al., Int. J. Biol. Sci. 4:379-386; Onilude et al., Int. Food Res. J. 20:1645-1651). Alternatively, poly alpha-1,6-glucan can be prepared using a glucosyltransferase (dextransucrase) such as (but not limited to) GTF1729, GTF1428, GTF5604, GTF6831, GTF8845, GTF0088, and GTF8117 as described in Int. Patent Appl. Publ. Nos. WO2015/183714 or WO2017/091533, or U.S. Pat. Appl. Publ. Nos. 2017/0218093 or 2018/0282385, all of which are incorporated herein by reference.

In some embodiments, the poly alpha-1,6-glucan ester compound comprises a backbone of glucose monomer units wherein greater than or equal to 40%, 45%, 50%, 55%, 60%, 65%, 70%, 75%, 80%, 85%, 90%, 95%, 96%, 97%, 98%, 99%, 99.5%, or 100% of the glucose monomer units are linked via alpha-1,6-glycosodic linkages. The backbone of the poly alpha-1,6-glucan derivative can comprise, for example, 0.5%, 1%, 2%, 3%, 4%, 5%, 10%, 15%, 20%, 25%, 30%, 35%, 40%, 45%, 50%, 55%, or 60% glucose monomer units which are linked via alpha-1,2, alpha-1,3, and/or alpha-1,4 glycosidic linkages. In some aspects, the poly alpha-1,6-glucan derivative comprises a backbone that is linear (unbranched).

Dextran “long chains” herein can comprise “substantially (or mostly) alpha-1,6-glucosidic linkages”, meaning that they can have at least about 98.0% alpha-1,6-glucosidic linkages in some aspects. Dextran herein can comprise a “branching structure” (branched structure, such as dendritic) in some aspects. It is contemplated that in this structure, long chains branch from other long chains, likely in an iterative manner (e.g., a long chain can be a branch from another long chain, which in turn can itself be a branch from another long chain, and so on). It is contemplated that long chains in this structure can be “similar in length”, meaning that the length (DP [degree of polymerization]) of at least 70% of all the long chains in a branching structure is within plus/minus 30% of the mean length of all the long chains of the branching structure.

Dextran in some embodiments can also comprise “short chains” branching from the long chains, typically being one to three glucose monomers in length, and typically comprising less than about 10% of all the glucose monomers of a dextran polymer. Such short chains typically comprise alpha-1,2-, alpha-1,3-, and/or alpha-1,4-glucosidic linkages (it is understood that there can also be a small percentage of such non-alpha-1,6 linkages in long chains in some aspects). In certain embodiments, the poly-1,6-glucan with branching is produced enzymatically according to the procedures in WO2015/183714 and WO2017/091533 (both incorporated herein by reference) where, for example, alpha-1,2-branching enzymes such as GTFJ18T1 or GTF9905 can be added during or after the production of the dextran polymer (polysaccharide). In some embodiments, any other enzyme known to produce alpha-1,2-branching can be added. Poly alpha-1,6-glucan with alpha-1,3-branching can be prepared as disclosed in Vuillemin et al. (2016, J. Biol Chem. 291:7687-7702), Int. Patent Appl. Publ. No. WO2021/007264, or U.S. Appl. No. 62/871,796 (as originally filed), which are incorporated herein by reference, which is incorporated herein by reference. The degree of branching of poly alpha-1,6-glucan or a poly alpha-1,6-glucan derivative in such embodiments has less than or equal to 50%, 40%, 30%, 20%, 10%, or 5% (or any integer value between 5% and 50%) of short branching, for example alpha-1,2- branching or 1,3-branching. In one embodiment, the poly alpha-1,6-glucan or the poly alpha-1,6-glucan derivative has a degree of alpha-1,2-branching that is less than 50%. In another embodiment, the poly alpha-1,6-glucan or the poly alpha-1,6-glucan derivative has a degree of alpha-1,2-branching that is at least 5%. In one embodiment, at least 5% of the backbone glucose monomer units of the poly alpha-1,6-glucan derivative have branches via alpha-1,2- or alpha-1,3-glycosidic linkages. In one embodiment, the poly apha-1,6-glucan or the poly alpha-1,6-glucan derivative comprises a backbone of glucose monomer units wherein greater than or equal to 40% of the glucose monomer units are linked via alpha-1,6-glycosidic linkages. In one embodiment, the poly alpha-1,6-glucan derivative comprises a backbone of glucose monomer units wherein greater than or equal to 40% of the glucose monomer units are linked via alpha-1,6-glycosidic linkages and at least 5% of the glucose monomer units have branches via alpha-1,2- or alpha-1,3-glycosidic linkages. In one embodiment, the poly alpha-1,6-glucan derivative comprises a backbone of glucose monomer units wherein greater than or equal to 40% of the glucose monomer units are linked via alpha-1,6-glycosidic linkages and at least 5% of the glucose monomer units have branches via alpha-1,2 linkages. In one embodiment, the poly alpha-1,6-glucan derivative comprises a backbone of glucose monomer units wherein greater than or equal to 40% of the glucose monomer units are linked via alpha-1,6-glycosidic linkages and at least 5% of the glucose monomer units have branches via alpha-1,3 linkages. In one embodiment, the poly alpha-1,6-glucan or poly alpha-1,6-glucan derivative is linear, or predominantly linear. In some aspects, about, at least about, or less than about, 1%, 2%, 3%, 4%, 5%, 10%, 15%, 20%, 25%, 30%, 35%, 40%, 50%, 55%, 60%, 65%, 70%, 75%, 80%, 85%, or 90% of the backbone glucose monomer units of a poly alpha-1,6-glucan or derivative thereof as presently disclosed can have branches via alpha-1,2 and/or alpha-1,3 glycosidic linkages. In some aspects, about, at least about, or less than about, 1%, 2%, 2.5%, 5%, 10%, 15%, 20%, 25%, 30%, 35%, 40%, or 45% of all the glycosidic linkages of an alpha-1,2- and/or alpha-1,3-branched poly alpha-1,6-glucan or derivative thereof as presently disclosed are alpha-1,2 and/or alpha-1,3 glycosidic linkages. The amount of alpha-1,2-branching or alpha-1,3-branching can be determined by NMR methods, as disclosed in the Examples.

The poly alpha-1,6-glucan and poly alpha-1,6-glucan derivatives disclosed herein can have a number-average degree of polymerization (DPn) or weight-average degree of polymerization (DPw) in the range of 5 to 4000. In some embodiments, the DPn or DPw can be in the range of 5 to 100, 5 to 500, 5 to 1000, 5 to 1500, 5 to 2000, 5 to 2500, 5 to 3000, or 5 to 4000. In some embodiments, the DPn or DPw can be in the range of 50 to 500, 50 to 1000, 50 to 1500, 50 to 2000, 50 to 3000, or 50 to 4000. In some embodiments, the DPn or DPw can be in the range of 400 to 4000, 400 to 3000, 400 to 2000, or 400 to 1000. In some embodiments, the DPn or DPw can be about, at least about, or less than about, 5, 10, 25, 50, 100, 250, 500, 1000, 1500, 2000, 2500, 3000, 4000, 5000, 6000, 5-100, 5-250, 5-500, 5-1000, 5-1500, 5-2000, 5-2500, 5-3000, 5-4000, 5-5000, 5-6000, 10-100, 10-250, 10-500, 10-1000, 10-1500, 10-2000, 10-2500, 10-3000, 10-4000, 10-5000, 10-6000, 25-100, 25-250, 25-500, 25-1000, 25-1500, 25-2000, 25-2500, 25-3000, 25-4000, 25-5000, 25-6000, 50-100, 50-250, 50-500, 50-1000, 50-1500, 50-2000, 50-2500, 50-3000, 50-4000, 50-5000, 50-6000, 100-100, 100-250, 100-500, 100-1000, 100-1500, 100-2000, 100-2500, 100-3000, 100-4000, 100-5000, or 100-6000.

A poly alpha-1,6-glucan ester compound as disclosed herein comprises:
(i) poly alpha-1,6-glucan substituted with at least one ester group selected from an aryl ester group, a first ester group comprising a first acyl group —CO—R″ wherein R″ comprises a chain of 1 to 24 carbon atoms, a second ester group comprising a second acyl group —CO—Cₓ—COOH, wherein —Cₓ— comprises a chain of 2 to 24 carbon atoms, or a combination thereof;
ii) a weight average degree of polymerization of at least 5; and
iii) a degree of substitution of about 0.001 to about 3.0;
wherein the poly alpha-1,6-glucan comprises a backbone of glucose monomer units wherein greater than or equal to 40% of the glucose monomer units are linked via alpha-1,6-glycosidic linkages, and optionally at least 5% of the backbone glucose monomer units have branches via alpha-1,2 and/or alpha-1,3 glycosidic linkages.

The poly alpha-1,6-glucan esters disclosed herein comprise poly alpha-1,6-glucan substituted with at least one ester group as disclosed herein. The at least one ester group can derivatize the poly alpha-1,6-glucan at the 2, 3, and/or 4 glucose carbon position of a glucose monomer on the backbone of the glucan, and/or at the 2, 3, 4, or 6 glucose carbon position(s) of a glucose monomer on a branch, if present. At unsubstituted positions in a glucose monomer, a hydroxyl group is present. The ester groups comprise hydrophobic groups which are independently linked to the poly alpha-1,6-glucan through an ester chemical linkage (COO—, —OOC), in place of the hydroxyl group originally present in the underivatized poly alpha-1,6-glucan.

In one embodiment, at least one ester group is a first ester group, and a poly alpha-1,6-glucan ester compound is termed an “ester” herein by virtue of comprising the substructure —Cc—O—CO—R″, where “—C_{G}—” represents a carbon of a polysaccharide glucose monomer unit, ‘O—CO—R″’ represents the first ester group, and ‘—CO—R″’ represents a first acyl group wherein R″ comprises a chain of 1 to 24 carbon atoms, the first acyl group being comprised in the first ester group.

In one embodiment, at least one ester group is a second ester group, and a poly alpha-1,6-glucan ester compound is termed an “ester” herein by virtue of comprising the substructure —C_{G}—O—CO—Cₓ—COOH, where “—C_{G}—” represents a carbon of a polysaccharide glucose monomer unit, “—O—CO—Cₓ—COOH” represents the second ester group, and “—CO—Cₓ—COOH” represents a second acyl group wherein —Cₓ— comprises a chain of 2 to 24 carbon atoms, the second acyl group being comprised in the second ester group.

In one embodiment, at least one ester group is an aryl ester group, and a poly alpha-1,6-glucan ester compound is termed an “ester” herein by virtue of comprising the substructure —C_{G}—O—CO—Ar, where “—C_{G}—” represents a carbon of a polysaccharide glucose monomer unit, “—O—CO—Ar” represents an aryl ester group, and “—CO—Ar” represents an aryl acyl group comprised in the aryl ester group. As used herein, the term “aryl” (abbreviated herein as “Ar”) means an aromatic/carbocyclic group having a single ring (e.g., phenyl), multiple rings (e.g., biphenyl), or multiple condensed rings in which at least one is aromatic, (e.g., 1,2,3,4-tetrahydronaphthyl, naphthyl, anthryl, or phenanthryl), which is optionally mono-, di-, or trisubstituted with alkyl groups such as a methyl, ethyl, or propyl group.

A poly alpha-1,6-glucan monoester contains one type of an ester group. A poly alpha-1,6-glucan mixed ester contains two or more types of ester groups.

Compositions can comprise, or consist essentially of, one or more poly alpha-1,6-glucan ester compounds as disclosed herein. In one embodiment, a composition can comprise one poly alpha-1,6-glucan ester compound. In another embodiment, a composition may comprise two or more poly alpha-1,6-glucan ester compounds, each containing different ester groups. For example, a composition can comprise a poly alpha-1,6-glucan ester compound wherein the ester group is an aryl ester group, and another poly alpha-1,6-glucan ester compound wherein the ester group is a first ester group comprising a first acyl group. Alternatively, a composition can comprise two or more poly alpha-1,6-glucan ester compounds each containing the same type of ester group (i.e. an aryl ester group) wherein the specific identities of the ester groups are different.

Poly alpha-1,6-glucan esters disclosed herein can be prepared using methods analogous to those disclosed for poly alpha-1,3-glucan esters. For example, poly alpha-1,6-glucan esters wherein at least one ester group is a first ester group comprising a first acyl group —CO—R″ may be prepared using methods similar to those disclosed in published patent application WO 2014/105698, in which poly alpha-1,3-glucan is contacted in a substantially anhydrous reaction with at least one acid catalyst, at least one acid anhydride, and at least one organic acid. Poly alpha-1,6-glucan esters wherein at least one ester group is a second ester group comprising a second acyl group —CO—Cₓ—COOH may be prepared using methods analogous to those disclosed in published patent application WO 2017/003808, in which poly alpha-1,3-glucan is contacted with a cyclic organic anhydride. Poly alpha-1,6-glucan esters wherein at least one ester group is an aryl group or a first ester group may be prepared using methods similar to those disclosed in published patent application WO 2018/098065, in which poly alpha-1,3-glucan is reacted with an acyl chloride or an acid anhydride under substantially anhydrous reaction conditions.

The term “degree of substitution” (DoS) as used herein refers to the average number of hydroxyl groups substituted in each monomeric unit (glucose) of a poly alpha-1,6-glucan ester compound, which includes the monomeric units within the backbone and within any alpha-1,2 or alpha-1,3 branches which may be present. Since there are at most three hydroxyl groups in a glucose monomeric unit in a poly alpha-1,6-glucan polymer or poly alpha-1,6-glucan ester compound, the overall degree of substitution can be no higher than 3.0. It would be understood by those skilled in the art that, since a poly alpha-1,6-glucan ester compound as disclosed herein can have a degree of substitution between about 0.001 to about 3.0, the substituents on the polysaccharide cannot only be hydroxyl. The degree of substitution of a poly alpha-1,6-glucan ester compound can be stated with reference to a specific substituent or with reference to the overall degree of substitution, that is, the sum of the DoS of each different substituent for a glucan ester compound as defined herein. As used herein, when the degree of substitution is not stated with reference to a specific substituent or substituent type, the overall degree of substitution of the poly alpha-1,6-glucan ester compound is meant. The target DoS can be chosen to provide the desired solubility and performance of a composition comprising a poly alpha-1,6-glucan ester compound in the specific application of interest.

The poly alpha-1,6-glucan esters disclosed herein have a DoS in the range of about 0.001 to about 3.0. In some embodiments the DoS can be from about 0.01 to about 1.5, or from about 0.01 to about 0.6, or from about 0.01 to about 0.2. Alternatively, the DoS can be about, at least about, or less than about, 0.001, 0.005, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1.0, 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, or any value between 0.001 and 3.0. The degree of substitution of a poly alpha-1,6-glucan ester compound can be stated with reference to a specific substituent or with reference to the overall degree of substitution, that is, the sum of the DoS of each different substituent type for a glucan ester compound as defined herein. As used herein, when the degree of substitution is not stated with reference to a specific substituent type, the overall degree of substitution of the poly alpha-1,6-glucan ester compound is meant.

In one embodiment of a poly alpha-1,6-glucan ester compound, at least one ester group is an aryl ester group. In one embodiment, the aryl ester group comprises a benzoyl group (—CO—C₆H₅), which is also referred to as a benzoate group. In a further embodiment, the aryl ester group comprises a benzoyl group substituted with at least one halogen, alkyl, halogenated alkyl, ether, cyano, or aldehyde group, or combinations thereof, as represented by the following Structures II(a) through II(r):

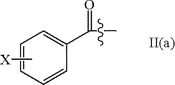

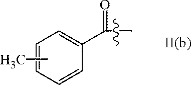

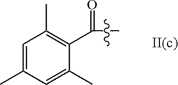

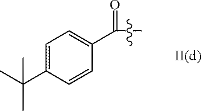

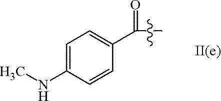

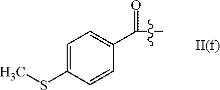

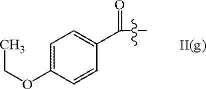

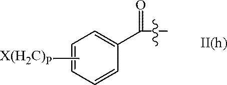

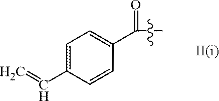

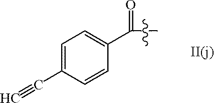

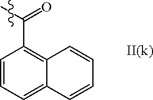

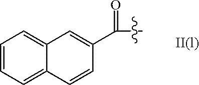

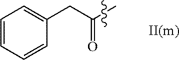

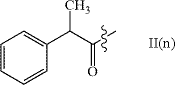

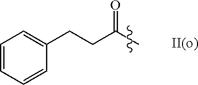

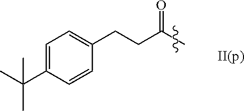

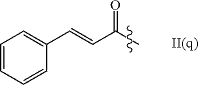

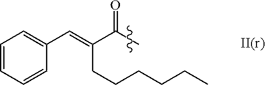

### Structures II(a) - II(r)

Many substituted benzoyl halides are commercially available and can be used to prepare substituted benzoate esters of poly alpha-1,6-glucan using methods known in the art.

In one embodiment of a poly alpha-1,6-glucan ester compound, at least one ester group is a first ester group comprising a first acyl group —CO—R″, wherein R″ comprises a chain of 1 to 26 carbon atoms. The first acyl group may be linear, branched, or cyclic. Examples of first acyl groups which are linear include: an ethanoyl group (—CO—CH₃),
a propanoyl group (—CO—CH₂—CH₃), a butanoyl group (—CO—CH₂—CH₂—CH₃),
a pentanoyl group (—CO—CH₂—CH₂—CH₂—CH₃),
a hexanoyl group (—CO—CH₂—CH₂—CH₂—CH₂—CH₃),
a heptanoyl group (—CO—CH₂—CH₂—CH₂—CH₂—CH₂—CH₃),
an octanoyl group (—CO—CH₂—CH₂—CH₂—CH₂—CH₂—CH₂—CH₃),
a nonanoyl group (—CO—CH₂—CH₂—CH₂—CH₂—CH₂—CH₂—CH₂—CH₃),
a decanoyl group (—CO—CH₂—CH₂—CH₂—CH₂—CH₂—CH₂—CH₂—CH₂—CH₃),
a undecanoyl group (—CO—CH₂—CH₂—CH₂—CH₂—CH₂—CH₂—CH₂—CH₂—CH₂—CH₃),
a dodecanoyl group (—CO—CH₂—CH₂—CH₂—CH₂—CH₂—CH₂—CH₂—CH₂—CH₂—CH₂—CH₃),
a tridecanoyl group (—CO—CH₂—CH₂—CH₂—CH₂—CH₂—CH₂—CH₂—CH₂—CH₂—CH₂—CH₂—CH₃),
a tetradecanoyl group (—CO—CH₂—CH₂—CH₂—CH₂—CH₂—CH₂—CH₂—CH₂—CH₂—CH₂—CH₂—CH₂—CH₃),
a pentadecanoyl group (—CO—CH₂—CH₂—CH₂—CH₂—CH₂—CH₂—CH₂—CH₂—CH₂—CH₂—CH₂—CH₂—CH₂—CH₃),
a hexadecanoyl group (—CO—CH₂—CH₂—CH₂—CH₂—CH₂—CH₂—CH₂—CH₂—CH₂—CH₂—CH₂—CH₂—CH₂—CH₂—CH₃),
a heptadecanoyl group (—CO—CH₂—CH₂—CH₂—CH₂—CH₂—CH₂—CH₂—CH₂—CH₂—CH₂—CH₂—CH₂—CH₂—CH₂—CH₂—CH₃),
an octadecanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₃),
a nonadecanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₂—CH₃),
an eicosanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₃),
an uneicosanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₃),
a docosanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₃),
a tricosanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₃),
a tetracosanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₃),
a pentacosanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₃), and
a hexacosanoyl group (—CO—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₂—CH₃), for example.

Common names for some of the above-listed acyl groups are acetyl (ethanoyl group), propionyl (propanoyl group), butyryl (butanoyl group), valeryl (pentanoyl group), caproyl (hexanoyl group); enanthyl (heptanoyl group), caprylyl (octanoyl group), pelargonyl (nonanoyl group), capryl (decanoyl group), lauroyl (dodecanoyl group), myristyl (tetradecanoyl group), palmityl (hexadecanoyl group), stearyl (octadecanoyl group), arachidyl (eicosanoyl group), behenyl (docosanoyl group), lignoceryl (tetracosanoyl group), and cerotyl (hexacosanoyl group).

Examples of first acyl groups which are branched include a 2-methylpropanoyl group; a 2-methylbutanoyl group; a 2,2-dimethylpropanoyl group; a 3-methylbutanoyl group; a 2-methylpentanoyl group; a 3-methylpentanoyl group; a 4-methylpentanoyl group; a 2,2-dimethylbutanoyl group; a 2,3-dimethylbutanoyl group; a 3,3-dimethylbutanoyl group; a 2-ethylbutanoyl group; and a 2-ethylhexanoyl group.

In one embodiment, the first acyl group encompasses cyclic acyl groups comprising —CO—R″, wherein R″ comprises a chain of 1 to 24 carbon atoms and contains at least one cyclic group. Examples of cyclic acyl groups include a cyclopropanoyl group; a cyclobutanoyl group; a cyclopentanoyl group; a cyclohexanoyl group; and a cycloheptanoyl group.

In another embodiment of a poly alpha-1,6-glucan ester compound, at least one ester group is a second ester group comprising a second acyl group —CO—Cₓ—COOH, wherein —Cₓ— comprises a chain of 2 to 24 carbon atoms. In certain embodiments herein, a poly alpha-1,6-glucan ester can be in an anionic form under aqueous conditions. This anionic behavior is due to the presence of a carboxyl group (COOH) in the esterified second acyl group (—CO—Cₓ—COOH). Carboxyl (COOH) groups of a poly alpha-1,6-glucan ester compound herein can convert to carboxylate (COO⁻) groups in aqueous conditions. These anionic groups can interact with salt cations such as potassium, sodium, lithium, or other cations, if present.

The terms “reaction” or “esterification reaction” are used interchangeably herein to refer to a reaction comprising, or consisting of, poly alpha-1,6-glucan and at least one cyclic organic anhydride. A reaction may be placed under suitable conditions (e.g., time, temperature, pH) for esterification of one or more hydroxyl groups of the glucose units of poly alpha-1,6-glucan with an acyl group provided by the cyclic organic anhydride, thereby yielding a poly alpha-1,6-glucan ester comprising a second acyl group —CO—Cₓ—COOH as defined herein.

A cyclic organic anhydride herein can have a formula represented by Structure III shown below:

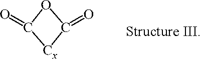

The —Cₓ— portion of Structure III typically comprises a chain of 2 to 24 carbon atoms. It is contemplated that, in some embodiments, the —Cₓ— portion can comprise a chain of 2 to 8, 2 to 16, 2 to 18, or 2 to 24 carbon atoms. During an esterification reaction, the anhydride group (—CO—O—CO—) of a cyclic organic anhydride breaks such that one end of the broken anhydride becomes a —COOH group and the other end is esterified to a hydroxyl group of poly alpha-1,6-glucan, thereby rendering an esterified second acyl group. Depending on the cyclic organic anhydride used, there typically can be one or two possible products of such an esterification reaction.

In general, each carbon in the chain, aside from being covalently bonded with an adjacent carbon atom(s) in the chain or a carbon atom of the flanking C═O and COOH groups, can also be bonded to hydrogen(s), a substituent group(s) such as an organic group, and/or be involved in a carbon-carbon double-bond. For example, a carbon atom in the —Cₓ— chain can be saturated (i.e., —CH₂—), double-bonded with an adjacent carbon atom in the —Cₓ— chain (e.g., —CH═CH—), and/or be bonded to a hydrogen and an organic group (i.e., one hydrogen is substituted with an organic group). Skilled artisans would understand how the carbon atoms of the —Cₓ— portion of a second acyl group can typically be bonded, given that carbon has a valency of four.

In certain embodiments, —Cₓ— of the second acyl group (—CO—Cₓ—COOH) further comprises only CH₂ groups. Examples of a second acyl group in which the —Cₓ— portion comprises only CH₂ groups are —CO—CH₂—CH₂—COOH, —CO—CH₂—CH₂—CH₂—COOH, —CO—CH₂—CH₂—CH₂—CH₂—COOH, —CO—CH₂—CH₂—CH₂—CH₂—CH₂—COOH, —CO—CH₂—CH₂—CH₂—CH₂—CH₂—CH₂—COOH, —CO—CH₂—CH₂—CH₂—CH₂—CH₂—CH₂—CH₂—COOH, —CO—CH₂—CH₂—CH₂—CH₂—CH₂—CH₂—CH₂—CH₂—CH₂—COOH, —CO—CH₂—CH₂—CH₂—CH₂—CH₂—CH₂—CH₂—CH₂—CH₂—CH₂—COOH, —CO—CH₂—CH₂—CH₂—CH₂—CH₂—CH₂—CH₂—CH₂—CH₂—CH₂—CH₂—COOH, —CO—CH₂—CH₂—CH₂—CH₂—CH₂—CH₂—CH₂—CH₂—CH₂—CH₂—CH₂—CH₂—COOH, —CO—CH₂—CH₂—CH₂—CH₂—CH₂—CH₂—CH₂—CH₂—CH₂—CH₂—CH₂—CH₂—CH₂—COOH, —CO—CH₂—CH₂—CH₂—CH₂—CH₂—CH₂—CH₂—CH₂—CH₂—CH₂—CH₂—CH₂—CH₂—CH₂—COOH, —CO—(CH₂)₁₅—COOH, —CO—(CH₂)₁₆—COOH, —CO—(CH₂)₁₇—COOH, —CO—(CH₂)₁₈—COOH, —CO—(CH₂)₁₉—COOH, —CO—(CH₂)₂₀—COOH, —CO—(CH₂)₂₁—COOH, —CO—(CH₂)₂₂—COOH, —CO—(CH₂)₂₃—COOH, and —CO—(CH₂)₂₄—COOH. These second acyl groups can be derived by reacting succinic anhydride, glutaric anhydride, adipic anhydride, pimelic anhydride, suberic anhydride, and other analogous anhydrides with poly alpha-1,6-glucan.

In some embodiments, —Cₓ— of the second acyl group (—CO—Cₓ—COOH)can further comprise (i) at least one double-bond in the carbon atom chain, and/or (ii) at least one branch comprising an organic group. For instance, —Cₓ— of the second acyl group can have at least one double-bond in the carbon atom chain. Examples of a second acyl group in which the —Cₓ— portion comprises a carbon-carbon double-bond include —CO—CH═CH—COOH, —CO—CH═CH—CH₂—COOH, —CO—CH═CH—CH₂—CH₂—COOH, —CO—CH═CH—CH₂—CH₂—CH₂—COOH, —CO—CH═CH—CH₂—CH₂—CH₂—CH₂—COOH, —CO—CH₂—CH═CH—COOH, —CO—CH₂—CH═CH—CH₂—COOH, —CO—CH₂—CH═CH—CH₂—CH₂—COOH, —CO—CH₂—CH═CH—CH₂—CH₂—CH₂—COOH, —CO—CH₂—CH₂—CH═CH—COOH, —CO—CH₂—CH₂—CH═CH—CH₂—COOH, —CO—CH₂—CH₂—CH═CH—CH₂—CH₂—COOH, —CO—CH₂—CH₂—CH₂—CH═CH—COOH, —CO—CH₂—CH₂—CH₂—CH═CH—CH₂—COOH,—CO—CH₂—CH₂—CH₂—CH₂—CH═CH—COOH, and analogues of these examples wherein —Cₓ— contains from 7 to 24 carbon atoms. Each of these second acyl groups may be derived by reacting the appropriate cyclic organic anhydride with poly alpha-1,6-glucan. For example, to produce a second acyl group comprising —CO—CH═CH—COOH, maleic anhydride may be reacted with poly alpha-1,6-glucan. Thus, a cyclic organic anhydride comprising a —Cₓ— portion represented in any of the above-listed second acyl groups (where the corresponding —Cₓ— portion of a cyclic organic anhydride is that portion linking each side of the anhydride group [—CO—O—CO—] together to form a cycle) can be reacted with poly alpha-1,6-glucan to produce an ester thereof having the corresponding second acyl group (—CO—Cₓ—COOH).

The —Cₓ— portion of the second acyl group (—CO—Cₓ—COOH)in some aspects herein can comprise at least one branch comprising an organic group. Examples of a second acyl group in which the —Cₓ— portion comprises at least one organic group branch include:

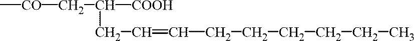 [SMILES: CCCCCCC=CCC(CC(C)=O)C(=O)O]

and

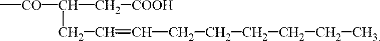 [SMILES: CCCCCCC=CCC(CC(=O)O)C(C)=O]

Each of these two second acyl groups may be derived by reacting 2-nonen-1-yl succinic anhydride with poly alpha-1,6-glucan. It can be seen that the organic group branch (generically termed “R^{b}” herein) in both these examples is —CH₂—CH═CH—CH₂—CH₂—CH₂—CH₂—CH₂—CH₃. It can also be seen that the R^{b} group substitutes for a hydrogen in the —Cₓ— carbon chain.

Thus, for example, a second acyl group (—CO—Cₓ—COOH)herein can be any of —CO—CH₂—CH₂—COOH, —CO—CH₂—CH₂—CH₂—COOH, —CO—CH₂—CH₂—CH₂—CH₂—COOH, —CO—CH₂—CH₂—CH₂—CH₂—CH₂—COOH, —CO—CH₂—CH₂—CH₂—CH₂—CH₂—CH₂—COOH, or analogous moieties wherein —Cₓ—contains from 7 to 24 carbon atoms but in which at least one, two, three, or more hydrogens thereof is/are substituted with an R^{b} group. Also for example, a first group (—CO—Cₓ—COOH)herein can be any of —CO—CH═CH—CH₂—COOH, —CO—CH═CH—CH₂—CH₂—COOH, —CO—CH═CH—CH₂—CH₂—CH₂—COOH, —CO—CH═CH—CH₂—CH₂—CH₂—CH₂—COOH, —CO—CH₂—CH═CH—COOH, —CO—CH₂—CH═CH—CH₂—COOH, —CO—CH₂—CH═CH—CH₂—CH₂—COOH, —CO—CH₂—CH═CH—CH₂—CH₂—CH₂—COOH, —CO—CH₂—CH₂—CH═CH—COOH, —CO—CH₂—CH₂—CH═CH—CH₂—COOH, —CO—CH₂—CH₂—CH═CH—CH₂—CH₂—COOH, —CO—CH₂—CH₂—CH₂—CH═CH—COOH, —CO—CH₂—CH₂—CH₂—CH═CH—CH₂—COOH, —CO—CH₂—CH₂—CH₂—CH₂—CH═CH—COOH, or analogous moieties wherein the —Cₓ—portion contains from 7 to 24 carbon atoms but in which at least one, two, three, or more hydrogens thereof is/are substituted with an R^{b} group (such second acyl groups are examples in which the —Cₓ— portion comprises at least one double-bond in the carbon atom chain and at least one branch comprising an organic group). Suitable examples of R^{b} groups herein include alkyl groups and alkenyl groups. An alkyl group herein can comprise 1-18 carbons (linear or branched), for example (e.g., methyl, ethyl, propyl, butyl, pentyl, hexyl, heptyl, octyl, nonyl, or decyl group). An alkenyl group herein can comprise 1-18 carbons (linear or branched), for example (e.g., methylene, ethenyl, propenyl, butenyl, pentenyl, hexenyl, heptenyl, octenyl [e.g., 2-octenyl], nonenyl [e.g., 2-nonenyl], or decenyl group). One of skill in the art would understand, based on the formula of the cyclic organic anhydride represented by Structure III and its involvement in the esterification process to prepare poly alpha-1,6-glucan esters as disclosed herein, what particular cyclic organic anhydride is suitable for deriving any of these second acyl groups.

Examples of cyclic organic anhydrides by name that may be used in a reaction with poly alpha-1,6-glucan to form a poly alpha-1,6-glucan ester compound wherein at least one ester group is a second ester group comprising a second acyl group —CO—Cₓ—COOH include maleic anhydride, methylsuccinic anhydride, methylmaleic anhydride, dimethylmaleic anhydride, 2-ethyl-3-methylmaleic anhydride, 2-hexyl-3-methylmaleic anhydride, 2-ethyl-3-methyl-2-pentenedioic anhydride, itaconic anhydride (2-methylenesuccinic anhydride), 2-nonen-1-yl succinic anhydride, and 2-octen-1-yl succinic anhydride. Alkenyl succinic anhydrides and alkylketene dimers, for example those derived from palmitic acid or other long chain carboxylic acids, can also be used. In particular, for example, maleic anhydride can be used to provide the second acyl group —CO—CH═CH—COOH; methylsuccinic anhydride can be used to provide the second acyl group —CO—CH₂—CH(CH₃)—COOH and/or —CO—CH(CH₃)—CH₂—COOH; methylmaleic anhydride can be used to provide the second acyl group —CO—CH═C(CH₃)—COOH and/or —CO—C(CH₃)═CH—COOH; dimethylmaleic anhydride can be used to provide the second acyl group —CO—C(CH₃)═C(CH₃)—COOH; 2-ethyl-3-methylmaleic anhydride can be used to provide the second acyl group —CO—C(CH₂CH₃)═C(CH₃)—COOH and/or —CO—C(CH₃)═C(CH₂CH₃)—COOH; 2-hexyl-3-methylmaleic anhydride can be used to provide the second acyl group —CO—C(CH₂CH₂CH₂CH₂CH₂CH₃)═C(CH₃)—COOH and/or —CO—C(CH₃)═C(CH₂CH₂CH₂CH₂CH₂CH₃)—COOH; itaconic anhydride can be used to provide the second acyl group —CO—CH₂—C(CH₂)—COOH and/or -CO—C(CH₂)—CH₂—COOH; 2-nonen-1-yl succinic anhydride can be used to provide the second acyl group —CO—CH₂—CH(CH₂CH═CHCH₂CH₂CH₂CH₂CH₂CH₃)—COOH and/or —CO—CH(CH₂CH═CHCH₂CH₂CH₂CH₂CH₂CH₃)—CH₂—COOH.

In one embodiment of a poly alpha-1,6-glucan ester compound, at least one ester group is an aryl ester group or a first ester group comprising a first acyl group —CO—R″ wherein R″ comprises a chain of 1 to 24 carbon atoms. In a further embodiment, the aryl ester group comprises a benzoyl group or a benzoyl group substituted with at least one halogen, alkyl, halogenated alkyl, ether, cyano, or aldehyde group, or a combination thereof. In an additional embodiment, at least one ester group is an aryl ester group or a first ester group comprising an acetyl group, a propionyl group, or a combination thereof. In yet another embodiment, at least one ester group is an aryl ester group or a first ester group comprising an acetyl or a propionyl group, and the aryl ester group comprises a benzoyl group or a benzoyl group substituted with at least one halogen, alkyl, halogenated alkyl, ether, cyano, or aldehyde group, or combinations thereof. In one embodiment, at least one ester group is an aryl ester comprising a benzoyl group, a first ester group comprising an acetyl group, or a combination thereof. In yet another embodiment, at least one ester group is an aryl ester comprising a benzoyl group, a first ester comprising a propionyl group, or a combination thereof.

In one embodiment of a poly alpha-1,6-glucan ester compound, at least one ester group comprises a first ester group comprising a first acyl group —CO—R″ wherein R″ comprises a chain of 1 to 24 carbon atoms. In one embodiment, R″ comprises a chain of 1 to 12 carbon atoms. In another embodiment, at least one ester group comprises a first ester group comprising a first acyl group, and the first acyl group comprises an acetyl group. In an additional embodiment, at least one ester group comprises a first ester group comprising a first acyl group, and the first acyl group comprises a propionyl group.

In another embodiment, at least one ester group comprises a second ester group comprising a second acyl group —CO—Cₓ—COOH, wherein —Cₓ—comprises a chain of 2 to 24 carbon atoms. In one embodiment, —Cₓ— comprises a chain of 2 to 12 carbon atoms. In one embodiment, at least one ester group comprises a second ester group comprising a second acyl group, wherein the second acyl group comprises —CO—CH₂—CH₂—COOH, —CO—CH₂—CH₂—CH₂—COOH, —CO—CH₂—CH₂—CH₂—CH₂—COOH, —CO—CH₂—CH₂—CH₂—CH₂—CH₂—COOH, or —CO—CH₂—CH₂—CH₂—CH₂—CH₂—CH₂—COOH. In an additional embodiment, at least one ester group comprises a second ester group comprising a second acyl group —CO—Cₓ—COOH, wherein —Cₓ— further comprises only CH₂ groups. In yet another embodiment, at least one ester group comprises a second ester group comprising a second acyl group —CO—Cₓ—COOH, wherein —Cₓ— further comprises at least one double-bond in the carbon atom chain, and/or at least one branch comprising an organic group.

In one embodiment of a poly alpha-1,6-glucan ester compound, at least one ester group is a first ester group comprising a first acyl group —CO—R″ and at least one ester group is a second ester group comprising a second acyl group —CO—Cₓ—COOH.

In one embodiment, a poly alpha-1,6-glucan ester disclosed herein comprises poly alpha-1,6-glucan succinate, poly alpha-1,6-glucan methylsuccinate, poly alpha-1,6-glucan 2-methylene succinate, poly alpha-1,6-glucan maleate, poly alpha-1,6-glucan methylmaleate, poly alpha-1,6-glucan dimethyl maleate, poly alpha-1,6-glucan 2-ethyl-3-methyl maleate, poly alpha-1,6-glucan 2-hexyl-3-methyl maleate, poly alpha-1,6-glucan 2-ethyl-3-methylglutaconate, poly alpha-1,6-glucan 2-nonen-1-yl-succinate, poly alpha-1,6-glucan 2-octene-1-yl succinate, poly alpha-1,6-glucan benzoate, poly alpha-1,6-glucan acetyl benzoate, poly alpha-1,6-glucan glutarate, poly alpha-1,6-glucan laurate, or mixtures thereof.

Depending upon the desired application, compositions comprising a poly alpha-1,6-glucan ester compound as disclosed herein can be formulated, for example, blended, mixed, or incorporated into, with one or more other materials and/or active ingredients suitable for use in various compositions, for example compositions for use in laundry care, textile/fabric care, and/or personal care products. The term “composition comprising a poly alpha-1,6-glucan ester compound” in this context may include, for example, aqueous formulations, rheology modifying compositions, fabric treatment/care compositions, laundry care formulations/compositions, fabric softeners or personal care compositions (hair, skin and oral care), each comprising a poly alpha-1,6-glucan ester compound as disclosed herein.

As used herein, the term “effective amount” refers to the amount of the substance used or administered that is suitable to achieve the desired effect. The effective amount of material may vary depending upon the application. One of skill in the art will typically be able to determine an effective amount for a particular application or subject without undo experimentation.

The term “resistance to enzymatic hydrolysis” refers to the relative stability of the poly alpha-1,6-glucan derivative to enzymatic hydrolysis. Having a resistance to hydrolysis is important for the use of these materials in applications wherein enzymes are present, such as in detergent, fabric care, and/or laundry care applications. In some embodiments, the poly alpha-1,6-glucan ester compound is resistant to cellulases. In other embodiments, the poly alpha-1,6-glucan ester compound is resistant to proteases. In still further embodiments, the poly alpha-1,6-glucan ester compound is resistant to amylases. In yet other embodiments, the poly alpha-1,6-glucan ester is resistant to mannanases. In other embodiments, the poly alpha-1,6-glucan ester is resistant to multiple classes of enzymes, for example, two or more cellulases, proteases, amylases, mannanases, or combinations thereof. Resistance to any particular enzyme will be defined as having at least 10, 20, 30, 40, 50, 60, 70, 80, 90, 95 or 100% of the materials remaining after treatment with the respective enzyme. The percentage remaining may be determined by measuring the supernatant after enzyme treatment using SEC-HPLC. The assay to measure enzyme resistance can be determined using the following procedure: A sample of the poly alpha-1,6-glucan ester compound is added to water in a vial and mixed using a PTFE magnetic stir bar to create a 1 percent by weight aqueous solution. The aqueous mixture is produced at pH 7.0 and 20° C. After the poly alpha-1,6-glucan ester compound thereof has completely dissolved, 1.0 milliliter (mL) (1 percent by weight of the enzyme formulation) of cellulase (PURADEX® EGL), amylase (PURASTAR® ST L) protease (SAVINASE® 16.0 L), or lipase (Lipex® 100 L) is added and mixed for 72 hours (hrs) at 20° C. After 72 hrs of stirring, the reaction mixture is heated to 70° C. for 10 minutes to inactivate the added enzyme, and the resulting mixture is cooled to room temperature and centrifuged to remove any precipitate. The supernatant is analyzed by SEC-HPLC for recovered poly alpha-1,6-glucan ester compound and compared to a control where no enzyme was added to the reaction mixture. Percent changes in area counts for the respective poly alpha-1,6-glucan ester compound thereof may be used to test the relative resistance of the materials to the respective enzyme treatment. Percent changes in area versus the total will be used to assess the relative amount of materials remaining after treatment with a particular enzyme. Materials having a percent recovery of at least 10%, preferably at least 50, 60, 70, 80, 90, 95 or 100% will be considered “resistant” to the respective enzyme treatment.

The phrase “aqueous composition” herein refers to a solution or mixture in which the solvent is at least about 1% by weight of water and which comprises the poly alpha-1,6-glucan ester.

The terms “hydrocolloid” and “hydrogel” are used interchangeably herein. A hydrocolloid refers to a colloid system in which water is the dispersion medium. A “colloid” herein refers to a substance that is microscopically dispersed throughout another substance. Therefore, a hydrocolloid herein can also refer to a dispersion, emulsion, mixture, or solution of the poly alpha-1,6-glucan ester compound in water or aqueous solution.

The term “aqueous solution” herein refers to a solution in which the solvent is water. The poly alpha-1,6-glucan ester compound can be dispersed, mixed, and/or dissolved in an aqueous solution. An aqueous solution can serve as the dispersion medium of a hydrocolloid herein.

The terms “dispersant” and “dispersion agent” are used interchangeably herein to refer to a material that promotes the formation and stabilization of a dispersion of one substance in another. A “dispersion” herein refers to an aqueous composition comprising one or more particles, for example, any ingredient of a personal care product, pharmaceutical product, food product, household product or industrial product that are scattered, or uniformly distributed, throughout the aqueous composition. It is believed that the poly alpha-1,6-glucan ester compound can act as dispersants in aqueous compositions disclosed herein.

The term “viscosity” as used herein refers to the measure of the extent to which a fluid or an aqueous composition such as a hydrocolloid resists a force tending to cause it to flow. Various units of viscosity that can be used herein include centipoise (cps) and Pascal-second (Pa·s). A centipoise is one one-hundredth of a poise; one poise is equal to 0.100 kg·m⁻¹·s⁻¹. Thus, the terms “viscosity modifier” and “viscosity-modifying agent” as used herein refer to anything that can alter/modify the viscosity of a fluid or aqueous composition.

The terms “fabric”, “textile”, and “cloth” are used interchangeably herein to refer to a woven or non-woven material having a network of natural and/or artificial fibers. Such fibers can be thread or yarn, for example.

A “fabric care composition” herein is any composition suitable for treating fabric in some manner. Suitable examples of such a composition include non-laundering fiber treatments (for desizing, scouring, mercerizing, bleaching, coloration, dying, printing, bio-polishing, anti-microbial treatments, anti-wrinkle treatments, stain resistance treatments, etc.), laundry care compositions (e.g., laundry care detergents), and fabric softeners.

The terms “detergent composition”, “heavy duty detergent” and “all-purpose detergent” are used interchangeably herein to refer to a composition useful for regular washing of a substrate, for example, dishware, cutlery, vehicles, fabrics, carpets, apparel, white and colored textiles at any temperature. Detergent compositions for treating of fabrics, hard surfaces and any other surfaces in the area of fabric and home care, include: laundry detergents, fabric conditioners (including softeners), laundry and rinse additives and care compositions, fabric freshening compositions, laundry prewash, laundry pretreat, hard surface treatment compositions, car care compositions, dishwashing compositions (including hand dishwashing and automatic dishwashing products), air care products, detergent contained on or in a porous substrate or nonwoven sheet, and other cleaner products for consumer or institutional use

The terms “cellulase” and “cellulase enzyme” are used interchangeably herein to refer to an enzyme that hydrolyzes β-1,4-D-glucosidic linkages in cellulose, thereby partially or completely degrading cellulose. Cellulase can alternatively be referred to as “β-1,4-glucanase”, for example, and can have endocellulase activity (EC 3.2.1.4), exocellulase activity (EC 3.2.1.91), or cellobiase activity (EC 3.2.1.21). A cellulase in certain embodiments herein can also hydrolyze β-1,4-D-glucosidic linkages in cellulose ether derivatives such as carboxymethyl cellulose. “Cellulose” refers to an insoluble polysaccharide having a linear chain of β-1,4-linked D-glucose monomeric units.

As used herein, the term “fabric hand” or “handle” is meant people’s tactile sensory response towards fabric which may be physical, physiological, psychological, social or any combination thereof. In some embodiments, the fabric hand may be measured using a PHABROMETER® System (available from Nu Cybertek, Inc. Davis, California) for measuring the relative hand value as given by the American Association of Textile Chemists and Colorists (AATCC test method “202-2012, Relative Hand Value of Textiles: Instrumental Method”).

The composition can be in the form of a liquid, a gel, a powder, a hydrocolloid, an aqueous solution, a granule, a tablet, a capsule, a bead or pastille, a single compartment sachet, a multi-compartment sachet, a single compartment pouch, or a multi-compartment pouch. In some embodiments, the composition is in the form of a liquid, a gel, a powder, a single compartment sachet, or a multi-compartment sachet.

A detergent composition can be used for hand wash, machine wash and/or other purposes such as soaking and/or pretreatment of fabrics, for example. A detergent composition may take the form of, for example, a laundry detergent; any wash-, rinse-, or dryer-added product; unit dose or spray. Detergent compositions in a liquid form may be in the form of an aqueous composition. In other embodiments, a detergent composition can be in a dry form such as a granular detergent or dryer-added sheet. Other non-limiting examples of detergent compositions can include: granular or powder-form all-purpose or heavy-duty washing agents; liquid, gel or paste-form all-purpose or heavy-duty washing agents; liquid or dry fine-fabric (e.g. delicates) detergents; cleaning auxiliaries such as bleach additives, “stain-stick”, or pre-treatments; substrate-laden products such as dry and wetted wipes, pads, or sponges; sprays and mists; water-soluble unit dose articles.

In some embodiments, compositions comprising a poly alpha-1,6-glucan ester compound as disclosed herein can be in the form of a fabric care composition. A fabric care composition can be used for hand wash, machine wash and/or other purposes such as soaking and/or pretreatment of fabrics, for example. A fabric care composition may take the form of, for example, a laundry detergent; fabric conditioner; any wash-, rinse-, or dryer-added product; unit dose or spray. Fabric care compositions in a liquid form may be in the form of an aqueous composition. In other embodiments, a fabric care composition can be in a dry form such as a granular detergent or dryer-added fabric softener sheet. Other non-limiting examples of fabric care compositions can include: granular or powder-form all-purpose or heavy-duty washing agents; liquid, gel or paste-form all-purpose or heavy-duty washing agents; liquid or dry fine-fabric (e.g. delicates) detergents; cleaning auxiliaries such as bleach additives, “stain-stick”, or pre-treatments; substrate-laden products such as dry and wetted wipes, pads, or sponges; sprays and mists; water-soluble unit dose articles.

In some embodiments, compositions comprising the poly alpha-1,6-glucan ester compound can be in the form of a personal care product. Personal care products include, but are not limited to, hair care compositions, skin care compositions, sun care compositions, body cleanser compositions, oral care compositions, wipes, beauty care compositions, cosmetic compositions, antifungal compositions, and antibacterial compositions. The personal care products can include cleansing, cleaning, protecting, depositing, moisturizing, conditioning, occlusive barrier, and emollient compositions.

As used herein, “personal care products” also includes products used in the cleaning, bleaching and/or disinfecting of hair, skin, scalp, and teeth, including, but not limited to shampoos, body lotions, shower gels, topical moisturizers, toothpaste, toothgels, mouthwashes, mouth rinses, anti-plaque rinses, and/or other topical cleansers. In some embodiments, these products are utilized on humans, while in other embodiments, these products find use with non-human animals (e.g., in veterinary applications). In one aspect, “personal care products” includes hair care products. The hair care product can be in the form of a powder, paste, gel, liquid, oil, ointment, spray, foam, tablet, a hair shampoo, a hair conditioner rinse or any combination thereof.

The product formulation comprising the poly alpha-1,6-glucan ester compound described herein may be optionally diluted with water, or a solution predominantly comprised of water, to produce a formulation with the desired poly alpha-1,6-glucan ester compound concentration for the target application. Clearly one of skill in the art can adjust the reaction components and/or dilution amounts to achieve the desired poly alpha-1,6-glucan ester concentration for the chosen personal care product.

The personal care compositions described herein may further comprise one or more dermatologically or cosmetically acceptable components known or otherwise effective for use in hair care or other personal care products, provided that the optional components are physically and chemically compatible with the essential components described herein, or do not otherwise unduly impair product stability, aesthetics, or performance. Non-limiting examples of such optional components are disclosed in International Cosmetic lngredient Dictionary, Ninth Edition, 2002, and CTFA Cosmetic Ingredient Handbook, Tenth Edition, 2004.

In one embodiment, the dermatologically acceptable carrier may comprise from about 10 wt% to about 99.9 wt%, alternatively from about 50 wt% to about 95 wt%, and alternatively from about 75 wt% to about 95 wt%, of a dermatologically acceptable carrier. Carriers suitable for use with the composition(s) may include, for example, those used in the formulation of hair sprays, mousses, tonics, gels, skin moisturizers, lotions, and leave-on conditioners. The carrier may comprise water; organic oils; silicones such as volatile silicones, amino or non-amino silicone gums or oils, and mixtures thereof; mineral oils; plant oils such as olive oil, castor oil, rapeseed oil, coconut oil, wheatgerm oil, sweet almond oil, avocado oil, macadamia oil, apricot oil, safflower oil, candlenut oil, false flax oil, tamanu oil, lemon oil and mixtures thereof; waxes; and organic compounds such as C₂-C₁₀ alkanes, acetone, methyl ethyl ketone, volatile organic C₁-C₁₂ alcohols, esters (with the understanding that the choice of ester(s) may be dependent on whether or not it may act as a carboxylic acid ester substrates for the perhydrolases) of C₁-C₂₀ acids and of C₁-C₈ alcohols such as methyl acetate, butyl acetate, ethyl acetate, and isopropyl myristate, dimethoxyethane, diethoxyethane, C₁₀-C₃₀ fatty alcohols such as lauryl alcohol, cetyl alcohol, stearyl alcohol, and behenyl alcohol; C₁₀-C₃₀ fatty acids such as lauric acid and stearic acid; C₁₀-C₃₀ fatty amides such as lauric diethanolamide; C₁₀-C₃₀ fatty alkyl esters such as C₁₀-C₃₀ fatty alkyl benzoates; hydroxypropylcellulose, and mixtures thereof. In one embodiment, the carrier comprises water, fatty alcohols, volatile organic alcohols, and mixtures thereof.

The composition(s) disclosed herein further may comprise from about 0.1% to about 10%, and alternatively from about 0.2% to about 5.0%, of a gelling agent to help provide the desired viscosity to the composition(s). Non-limiting examples of suitable optional gelling agents include crosslinked carboxylic acid polymers; unneutralized crosslinked carboxylic acid polymers; unneutralized modified crosslinked carboxylic acid polymers; crosslinked ethylene/maleic anhydride copolymers; unneutralized crosslinked ethylene/maleic anhydride copolymers (e.g., EMA 81 commercially available from Monsanto); unneutralized crosslinked alkyl ether/acrylate copolymers (e.g., SALCARE™ SC90 commercially available from Allied Colloids); unneutralized crosslinked copolymers of sodium polyacrylate, mineral oil, and PEG-1 trideceth-6 (e.g., SALCARE™ SC91 commercially available from Allied Colloids); unneutralized crosslinked copolymers of methyl vinyl ether and maleic anhydride (e.g., STABILEZE™ QM-PVM/MA copolymer commercially available from International Specialty Products); hydrophobically modified nonionic cellulose polymers; hydrophobically modified ethoxylate urethane polymers (e.g., UCARE™ Polyphobe Series of alkali swellable polymers commercially available from Union Carbide); and combinations thereof. In this context, the term “unneutralized” means that the optional polymer and copolymer gelling agent materials contain unneutralized acid monomers. Preferred gelling agents include water-soluble unneutralized crosslinked ethylene/maleic anhydride copolymers, water-soluble unneutralized crosslinked carboxylic acid polymers, water-soluble hydrophobically modified nonionic cellulose polymers and surfactant/fatty alcohol gel networks such as those suitable for use in hair conditioning products.

The poly alpha-1,6-glucan ester compounds described herein may be incorporated into hair care compositions and products, such as but not limited to, hair conditioning agents. Hair conditioning agents are well known in the art, see for example Green et al. (WO0107009), and are available commercially from various sources. Suitable examples of hair conditioning agents include, but are not limited to, cationic polymers, such as cationized guar gum, diallyl quaternary ammonium salt/acrylamide copolymers, quaternized polyvinylpyrrolidone and derivatives thereof, and various polyquaternium-compounds; cationic surfactants, such as stearalkonium chloride, centrimonium chloride, and sapamin hydrochloride; fatty alcohols, such as behenyl alcohol; fatty amines, such as stearyl amine; waxes; esters; nonionic polymers, such as polyvinylpyrrolidone, polyvinyl alcohol, and polyethylene glycol; silicones; siloxanes, such as decamethylcyclopentasiloxane; polymer emulsions, such as amodimethicone; and nanoparticles, such as silica nanoparticles and polymer nanoparticles.

The hair care products may also include additional components typically found in cosmetically acceptable media. Non-limiting examples of such components are disclosed in International Cosmetic Ingredient Dictionary, Ninth Edition, 2002, and CTFA Cosmetic Ingredient Handbook, Tenth Edition, 2004. A non-limiting list of components often included in a cosmetically acceptable medium for hair care are also described by Philippe et al. in U.S. Pat. No. 6,280,747, and by Omura et al. in U.S. Pat. No. 6,139,851 and Cannell et al. in U.S. Pat. No. 6,013,250, all of which are incorporated herein by reference. For example, hair care compositions can be aqueous, alcoholic or aqueous-alcoholic solutions, the alcohol preferably being ethanol or isopropanol, in a proportion of from about 1 to about 75% by weight relative to the total weight, for the aqueous-alcoholic solutions. Additionally, the hair care compositions may contain one or more conventional cosmetic or dermatological additives or adjuvants including but not limited to, antioxidants, preserving agents, fillers, surfactants, UVA and/or UVB sunscreens, fragrances, thickeners, gelling agents, wetting agents and anionic, nonionic or amphoteric polymers, and dyes or pigments.

The hair care compositions and methods may also include at least one coloring agents such as any dye, lake, pigment, and the like that may be used to change the color of hair, skin, or nails. Hair coloring agents are well known in the art (see for example Green et al. supra, CFTA International Color Handbook, 2^{nd} ed., Micelle Press, England (1992) and Cosmetic Handbook, US Food and Drug Administration, FDA/IAS Booklet (1992)), and are available commercially from various sources (for example Bayer, Pittsburgh, PA; Ciba-Geigy, Tarrytown, NY; ICI, Bridgewater, NJ; Sandoz, Vienna, Austria; BASF, Mount Olive, NJ; and Hoechst, Frankfurt, Germany). Suitable hair coloring agents include, but are not limited to dyes, such as 4-hydroxypropylamino-3-nitrophenol, 4-amino-3-nitrophenol, 2-amino-6-chloro-4-nitrophenol, 2-nitro-paraphenylenediamine, N,N-hydroxyethyl-2-nitro-phenylenediamine, 4-nitro-indole, Henna, HC Blue 1, HC Blue 2, HC Yellow 4, HC Red 3, HC Red 5, Disperse Violet 4, Disperse Black 9, HC Blue 7, HC Blue 12, HC Yellow 2, HC Yellow 6, HC Yellow 8, HC Yellow 12, HC Brown 2, D&C Yellow 1, D&C Yellow 3, D&C Blue 1, Disperse Blue 3, Disperse violet 1, eosin derivatives such as D&C Red No. 21 and halogenated fluorescein derivatives such as D&C Red No. 27, D&C Red Orange No. 5 in combination with D&C Red No. 21 and D&C Orange No. 10; and pigments, such as D&C Red No. 36 and D&C Orange No. 17, the calcium lakes of D&C Red Nos. 7, 11, 31 and 34, the barium lake of D&C Red No. 12, the strontium lake of D&C Red No. 13, the aluminum lakes of FD&C Yellow No. 5, of FD&C Yellow No. 6, of D&C Red No. 27, of D&C Red No. 21, and of FD&C Blue No. 1, iron oxides, manganese violet, chromium oxide, titanium dioxide, titanium dioxide nanoparticles, zinc oxide, barium oxide, ultramarine blue, bismuth citrate, and carbon black particles. In one embodiment, the hair coloring agents are D&C Yellow 1 and 3, HC Yellow 6 and 8, D&C Blue 1, HC Blue 1, HC Brown 2, HC Red 5, 2-nitro-paraphenylenediamine, N,N-hydroxyethyl-2-nitro-phenylenediamine, 4-nitro-indole, and carbon black. Metallic and semiconductor nanoparticles may also be used as hair coloring agents due to their strong emission of light (U.S. Pat. Application Publication No. 2004-0010864 to Vic et al.).

Hair care compositions may include, but are not limited to, shampoos, conditioners, lotions, aerosols, gels, mousses, and hair dyes.

Personal care products may be in the form of lotions, creams, pastes, balms, ointments, pomades, gels, liquids, or combinations thereof. A personal care product can also be in the form of makeup, lipstick, mascara, rouge, foundation, blush, eyeliner, lip liner, lip gloss, other cosmetics, sunscreen, sun block, nail polish, mousse, hair spray, styling gel, nail conditioner, bath gel, shower gel, body wash, face wash, shampoo, hair conditioner (leave-in or rinse-out), cream rinse, hair dye, hair coloring product, hair shine product, hair serum, hair anti-frizz product, hair split-end repair product, lip balm, skin conditioner, cold cream, moisturizer, body spray, soap, body scrub, exfoliant, astringent, scruffing lotion, depilatory, permanent waving solution, antidandruff formulation, antiperspirant composition, deodorant, shaving product, pre-shaving product, after-shaving product, cleanser, skin gel, rinse, dentifrice composition, toothpaste, or mouthwash, for example.

Personal care products can include the poly alpha-1,6-glucan ester compounds as disclosed herein, and can further comprise personal care active ingredient materials including sun screen agents, moisturizers, humectants, benefiting agents for hair, skin, nails and mouth, depositing agents such as surfactants, occlusive agents, moisture barriers, lubricants, emollients, anti-aging agents, antistatic agents, abrasive, antimicrobials, conditioners, exfoliants, fragrances, viscosifying agents, salts, lipids, phospholipids, vitamins, foam stabilizers, pH modifiers, preservatives, suspending agents, silicone oils, silicone derivatives, essential oils, oils, fats, fatty acids, fatty acid esters, fatty alcohols, waxes, polyols, hydrocarbons, and mixtures thereof. An active ingredient is generally recognized as an ingredient that causes an intended pharmacological effect.

In certain embodiments, a skin care product can include at least one active ingredient for the treatment or prevention of skin ailments, providing a cosmetic effect, or for providing a moisturizing benefit to skin, such as zinc oxide, petrolatum, white petrolatum, mineral oil, cod liver oil, lanolin, dimethicone, hard fat, vitamin A, allantoin, calamine, kaolin, glycerin, or colloidal oatmeal, and combinations of these. A skin care product may include one or more natural moisturizing factors such as ceramides, hyaluronic acid, glycerin, squalane, amino acids, cholesterol, fatty acids, triglycerides, phospholipids, glycosphingolipids, urea, linoleic acid, glycosaminoglycans, mucopolysaccharide, sodium lactate, or sodium pyrrolidone carboxylate, for example. Other ingredients that may be included in a skin care product include, without limitation, glycerides, apricot kernel oil, canola oil, squalane, squalene, coconut oil, corn oil, jojoba oil, jojoba wax, lecithin, olive oil, safflower oil, sesame oil, shea butter, soybean oil, sweet almond oil, sunflower oil, tea tree oil, shea butter, palm oil, cholesterol, cholesterol esters, wax esters, fatty acids, and orange oil.

Various examples of personal care formulations comprising at least one poly alpha-1,6-glucan derivative as presently disclosed are disclosed below (1-3)

A hair conditioner composition comprising: cetyl alcohol (1-3%), isopropyl myristate (1-3%), hydroxyethyl cellulose (Natrosol® 250 HHR), 0.1-1%, poly alpha-1,6-glucan derivative (0.1-2%), potassium salt (0.1-0.5%), Germaben® ll preservative (0.5%, available from International Specialty Products), and the balance being water.

A hair shampoo composition comprising: 5-20% sodium laureth sulfate, 1-2 wt% cocamidopropyl betaine, 1-2 wt% sodium chloride, 0.1-2% poly alpha-1,6-glucan derivative, preservative (0.1-0.5%), and the balance being water.

A skin lotion composition comprising: 1-5% glycerin, 1-5% glycol stearate, 1-5% stearic acid, 1-5% mineral oil, 0.5-1% acetylated lanolin (Lipolan® 98), 0.1-0.5 cetyl alcohol, 0.2-1 % triethanolamine, 0.1-1 wt% Germaben® II preservative, 0.5-2 wt% poly alpha-1,6-glucan derivative, and the balance being water.

Personal care compositions disclosed herein can be in the form of an oral care composition. Examples of oral care compositions include dentifrices, toothpaste, mouth wash, mouth rinse, chewing gum, and edible strips that provide some form of oral care (e.g., treatment or prevention of cavities [dental caries], gingivitis, plaque, tartar, and/or periodontal disease). An oral care composition can also be for treating an “oral surface”, which encompasses any soft or hard surface within the oral cavity including surfaces of the tongue, hard and soft palate, buccal mucosa, gums and dental surfaces. A “dental surface” herein is a surface of a natural tooth or a hard surface of artificial dentition including a crown, cap, filling, bridge, denture, or dental implant, for example.

One or more poly alpha-1,6-glucan esters comprised in an oral care composition typically are provided therein as a thickening agent and/or dispersion agent, which may be useful to impart a desired consistency and/or mouth feel to the composition. An oral care composition herein can comprise about 0.01-15.0 wt% (e.g., ~0.1 -10 wt% or ~0.1-5.0 wt%, ~0.1-2.0 wt%) of one or more poly alpha-1,6-glucan esters disclosed herein. One or more other thickening agents or dispersion agents can also be provided in an oral care composition herein, such as a carboxyvinyl polymer, carrageenan (e.g., L-carrageenan), natural gum (e.g., karaya, xanthan, gum arabic, tragacanth), colloidal magnesium aluminum silicate, or colloidal silica, for example.

An oral care composition herein may be a toothpaste or other dentifrice, for example. Such compositions, as well as any other oral care composition herein, can additionally comprise, without limitation, one or more of an anticaries agent, antimicrobial or antibacterial agent, anticalculus or tartar control agent, surfactant, abrasive, pH-modifying agent, foam modulator, humectant, flavorant, sweetener, pigment/colorant, whitening agent, and/or other suitable components.

An anticaries agent herein can be an orally acceptable source of fluoride ions. Suitable sources of fluoride ions include fluoride, monofluorophosphate and fluorosilicate salts as well as amine fluorides, including olaflur (N′-octadecyltrimethylendiamine-N,N,N′-tris(2-ethanol)-dihydrofluoride), for example. An anticaries agent can be present in an amount providing a total of about 100-20000 ppm, about 200-5000 ppm, or about 500-2500 ppm, fluoride ions to the composition, for example. In oral care compositions in which sodium fluoride is the sole source of fluoride ions, an amount of about 0.01-5.0 wt%, about 0.05-1.0 wt%, or about 0.1-0.5 wt%, sodium fluoride can be present in the composition, for example.

An antimicrobial or antibacterial agent suitable for use in an oral care composition herein includes, for example, phenolic compounds (e.g., 4-allylcatechol; p-hydroxybenzoic acid esters such as benzylparaben, butylparaben, ethylparaben, methylparaben and propylparaben; 2-benzylphenol; butylated hydroxyanisole; butylated hydroxytoluene; capsaicin; carvacrol; creosol; eugenol; guaiacol; halogenated bisphenolics such as hexachlorophene and bromochlorophene; 4-hexylresorcinol; 8-hydroxyquinoline and salts thereof; salicylic acid esters such as menthyl salicylate, methyl salicylate and phenyl salicylate; phenol; pyrocatechol; salicylanilide; thymol; halogenated diphenylether compounds such as triclosan and triclosan monophosphate), copper (II) compounds (e.g., copper (II) chloride, fluoride, sulfate and hydroxide), zinc ion sources (e.g., zinc acetate, citrate, gluconate, glycinate, oxide, and sulfate), phthalic acid and salts thereof (e.g., magnesium monopotassium phthalate), hexetidine, octenidine, sanguinarine, benzalkonium chloride, domiphen bromide, alkylpyridinium chlorides (e.g. cetylpyridinium chloride, tetradecylpyridinium chloride, N-tetradecyl-4-ethylpyridinium chloride), iodine, sulfonamides, bisbiguanides (e.g., alexidine, chlorhexidine, chlorhexidine digluconate), piperidino derivatives (e.g., delmopinol, octapinol), magnolia extract, grapeseed extract, rosemary extract, menthol, geraniol, citral, eucalyptol, antibiotics (e.g., augmentin, amoxicillin, tetracycline, doxycycline, minocycline, metronidazole, neomycin, kanamycin, clindamycin), and/or any antibacterial agents disclosed in U.S. Pat. No. 5776435, which is incorporated herein by reference. One or more antimicrobial agents can optionally be present at about 0.01-10 wt% (e.g., 0.1-3 wt%), for example, in the disclosed oral care composition.

An anticalculus or tartar control agent suitable for use in an oral care composition herein includes, for example, phosphates and polyphosphates (e.g., pyrophosphates), polyaminopropanesulfonic acid (AMPS), zinc citrate trihydrate, polypeptides (e.g., polyaspartic and polyglutamic acids), polyolefin sulfonates, polyolefin phosphates, diphosphonates (e.g.,azacycloalkane-2,2-diphosphonates such as azacycloheptane-2,2-diphosphonic acid), N-methyl azacyclopentane-2,3-diphosphonic acid, ethane-1-hydroxy-1,1-diphosphonic acid (EHDP), ethane-1-amino-1, 1-diphosphonate, and/or phosphonoalkane carboxylic acids and salts thereof (e.g., their alkali metal and ammonium salts). Useful inorganic phosphate and polyphosphate salts include, for example, monobasic, dibasic and tribasic sodium phosphates, sodium tripolyphosphate, tetrapolyphosphate, mono-, di-, tri- and tetra-sodium pyrophosphates, disodium dihydrogen pyrophosphate, sodium trimetaphosphate, sodium hexametaphosphate, or any of these in which sodium is replaced by potassium or ammonium. Other useful anticalculus agents in certain embodiments include anionic polycarboxylate polymers (e.g., polymers or copolymers of acrylic acid, methacrylic, and maleic anhydride such as polyvinyl methyl ether/maleic anhydride copolymers). Still other useful anticalculus agents include sequestering agents such as hydroxycarboxylic acids (e.g., citric, fumaric, malic, glutaric and oxalic acids and salts thereof) and aminopolycarboxylic acids (e.g., EDTA). One or more anticalculus or tartar control agents can optionally be present at about 0.01-50 wt% (e.g., about 0.05-25 wt% or about 0.1-15 wt%), for example, in the disclosed oral care composition.

A surfactant suitable for use in an oral care composition herein may be anionic, non-ionic, or amphoteric, for example. Suitable anionic surfactants include, without limitation, water-soluble salts of C₈-₂₀ alkyl sulfates, sulfonated monoglycerides of C₈-2₀ fatty acids, sarcosinates, and taurates. Examples of anionic surfactants include sodium lauryl sulfate, sodium coconut monoglyceride sulfonate, sodium lauryl sarcosinate, sodium lauryl isoethionate, sodium laureth carboxylate and sodium dodecyl benzenesulfonate. Suitable non-ionic surfactants include, without limitation, poloxamers, polyoxyethylene sorbitan esters, fatty alcohol ethoxylates, alkylphenol ethoxylates, tertiary amine oxides, tertiary phosphine oxides, and dialkyl sulfoxides. Suitable amphoteric surfactants include, without limitation, derivatives of C₈-₂₀ aliphatic secondary and tertiary amines having an anionic group such as a carboxylate, sulfate, sulfonate, phosphate or phosphonate. An example of a suitable amphoteric surfactant is cocoamidopropyl betaine. One or more surfactants are optionally present in a total amount of about 0.01-10 wt% (e.g., about 0.05-5.0 wt% or about 0.1-2.0 wt%), for example, in the disclosed oral care composition.

An abrasive suitable for use in an oral care composition herein may include, for example, silica (e.g., silica gel, hydrated silica, precipitated silica), alumina, insoluble phosphates, calcium carbonate, and resinous abrasives (e.g., a urea-formaldehyde condensation product). Examples of insoluble phosphates useful as abrasives herein are orthophosphates, polymetaphosphates and pyrophosphates, and include dicalcium orthophosphate dihydrate, calcium pyrophosphate, beta-calcium pyrophosphate, tricalcium phosphate, calcium polymetaphosphate and insoluble sodium polymetaphosphate. One or more abrasives are optionally present in a total amount of about 5-70 wt% (e.g., about 10-56 wt% or about 15-30 wt%), for example, in the disclosed oral care composition. The average particle size of an abrasive in certain embodiments is about 0.1-30 microns (e.g., about 1-20 microns or about 5-15 microns).

An oral care composition in certain embodiments may comprise at least one pH-modifying agent. Such agents may be selected to acidify, make more basic, or buffer the pH of a composition to a pH range of about 2-10 (e.g., pH ranging from about 2-8, 3-9, 4-8, 5-7, 6-10, or 7-9). Examples of pH-modifying agents useful herein include, without limitation, carboxylic, phosphoric and sulfonic acids; acid salts (e.g., monosodium citrate, disodium citrate, monosodium malate); alkali metal hydroxides (e.g. sodium hydroxide, carbonates such as sodium carbonate, bicarbonates, sesquicarbonates); borates; silicates; phosphates (e.g., monosodium phosphate, trisodium phosphate, pyrophosphate salts); and imidazole.

A foam modulator suitable for use in an oral care composition herein may be a polyethylene glycol (PEG), for example. High molecular weight PEGs are suitable, including those having an average molecular weight of about 200000-7000000 (e.g., about 500000-5000000 or about 1000000-2500000), for example. One or more PEGs are optionally present in a total amount of about 0.1-10 wt% (e.g. about 0.2-5.0 wt% or about 0.25-2.0 wt%), for example, in the disclosed oral care composition.

An oral care composition in certain embodiments may comprise at least one humectant. A humectant in certain embodiments may be a polyhydric alcohol such as glycerin, sorbitol, xylitol, or a low molecular weight PEG. Most suitable humectants also may function as a sweetener herein. One or more humectants are optionally present in a total amount of about 1.0-70 wt% (e.g., about 1.0-50 wt%, about 2-25 wt%, or about 5-15 wt%), for example, in the disclosed oral care composition.

A natural or artificial sweetener may optionally be comprised in an oral care composition herein. Examples of suitable sweeteners include dextrose, sucrose, maltose, dextrin, invert sugar, mannose, xylose, ribose, fructose, levulose, galactose, corn syrup (e.g., high fructose corn syrup or corn syrup solids), partially hydrolyzed starch, hydrogenated starch hydrolysate, sorbitol, mannitol, xylitol, maltitol, isomalt, aspartame, neotame, saccharin and salts thereof, dipeptide-based intense sweeteners, and cyclamates. One or more sweeteners are optionally present in a total amount of about 0.005-5.0 wt%, for example, in the disclosed oral care composition.

A natural or artificial flavorant may optionally be comprised in an oral care composition herein. Examples of suitable flavorants include vanillin; sage; marjoram; parsley oil; spearmint oil; cinnamon oil; oil of wintergreen (methylsalicylate); peppermint oil; clove oil; bay oil; anise oil; eucalyptus oil; citrus oils; fruit oils; essences such as those derived from lemon, orange, lime, grapefruit, apricot, banana, grape, apple, strawberry, cherry, or pineapple; bean-and nut-derived flavors such as coffee, cocoa, cola, peanut, or almond; and adsorbed and encapsulated flavorants. Also encompassed within flavorants herein are ingredients that provide fragrance and/or other sensory effect in the mouth, including cooling or warming effects. Such ingredients include, without limitation, menthol, menthyl acetate, menthyl lactate, camphor, eucalyptus oil, eucalyptol, anethole, eugenol, cassia, oxanone, lrisone®, propenyl guaiethol, thymol, linalool, benzaldehyde, cinnamaldehyde, N-ethyl-p-menthan-3-carboxamine, N,2,3-trimethyl-2-isopropylbutanamide, 3-(1-menthoxy)-propane-1,2-diol, cinnamaldehyde glycerol acetal (CGA), and menthone glycerol acetal (MGA). One or more flavorants are optionally present in a total amount of about 0.01-5.0 wt% (e.g., about 0.1-2.5 wt%), for example, in the disclosed oral care composition.

An oral care composition in certain embodiments may comprise at least one bicarbonate salt. Any orally acceptable bicarbonate can be used, including alkali metal bicarbonates such as sodium or potassium bicarbonate, and ammonium bicarbonate, for example. One or more bicarbonate salts are optionally present in a total amount of about 0.1-50 wt% (e.g., about 1-20 wt%), for example, in the disclosed oral care composition.

An oral care composition in certain embodiments may comprise at least one whitening agent and/or colorant. A suitable whitening agent is a peroxide compound such as any of those disclosed in U.S. Pat. No. 8540971, which is incorporated herein by reference. Suitable colorants herein include pigments, dyes, lakes and agents imparting a particular luster or reflectivity such as pearling agents, for example. Specific examples of colorants useful herein include talc; mica; magnesium carbonate; calcium carbonate; magnesium silicate; magnesium aluminum silicate; silica; titanium dioxide; zinc oxide; red, yellow, brown and black iron oxides; ferric ammonium ferrocyanide; manganese violet; ultramarine; titaniated mica; and bismuth oxychloride. One or more colorants are optionally present in a total amount of about 0.001-20 wt% (e.g., about 0.01-10 wt% or about 0.1-5.0 wt%), for example, in the disclosed oral care composition.

Additional components that can optionally be included in an oral composition herein include one or more enzymes (above), vitamins, and anti-adhesion agents, for example. Examples of vitamins useful herein include vitamin C, vitamin E, vitamin B5, and folic acid. Examples of suitable anti-adhesion agents include solbrol, ficin, and quorum-sensing inhibitors.

The composition can be in any useful form, for example, as powders, granules, pastes, bars, unit dose, or liquid.

The unit dose form may be water-soluble, for example, a water-soluble unit dose article comprising a water-soluble film and a liquid or solid laundry detergent composition, also referred to as a pouch. A water-soluble unit dose pouch comprises a water-soluble film which fully encloses the liquid or solid detergent composition in at least one compartment. The water-soluble unit dose article may comprise a single compartment or multiple compartments. The water-soluble unit dose article may comprise at least two compartments or at least three compartments. The compartments may be arranged in a superposed orientation or in a side-by-side orientation.

A unit dose article is typically a closed structure, made of the water-soluble film enclosing an internal volume which comprises the liquid or solid laundry detergent composition. The pouch can be of any form and shape which is suitable to hold and protect the composition, e.g. without allowing the release of the composition from the pouch prior to contact of the pouch to water.

A liquid detergent composition may be aqueous, typically containing up to about 70% by weight of water and 0% to about 30% by weight of organic solvent. It may also be in the form of a compact gel type containing less than or equal to 30% by weight water.

The poly alpha-1,6-glucan ester compounds disclosed herein can be used as an ingredient in the desired product or may be blended with one or more additional suitable ingredients and used as, for example, fabric care applications, laundry care applications, and/or personal care applications. Any of the disclosed compositions, for example, a fabric care, a laundry care or a personal care composition can comprise in the range of 0.01 to 99 percent by weight of the poly alpha-1,6-glucan ester compound, based on the total dry weight of the composition (dry solids basis). The term “total dry weight” means the weight of the composition excluding any solvent, for example, any water that might be present. In other embodiments, the composition comprises 0.1 to 10% or 0.1 to 9% or 0.5 to 8% or 1 to 7% or 1 to 6% or 1 to 5% or 1 to 4% or 1 to 3% or 5 to 10% or 10 to 15% or 15 to 20% or 20 to 25% or 25 to 30% or 30 to 35% or 35 to 40% or 40 to 45% or 45 to 50% or 50 to 55% or 55 to 60% or 60 to 65% or 65 to 70% or 70 to 75% or 75 to 80% or 80 to 85% or 85 to 90% or 90 to 95% or 95 to 99% by weight of the poly alpha-1,6-glucan ester compound, wherein the percentages by weight are based on the total dry weight of the composition.

The composition can further comprise at least one of a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer inhibiting agent, a chelating agent, a hueing dye, a calcium cation, a magnesium cation, a visual signaling ingredient, an anti-foam, a structurant, a thickener, an anti-caking agent, a starch, sand, a gelling agents, or a combination thereof. In one embodiment, the enzyme is a cellulase. In another embodiment, the enzyme is a protease. In yet another embodiment, the enzyme is an amylase.

The composition can be a detergent composition useful for, for example, fabric care, laundry care and/or personal care and may further contain one or more active enzymes. Non-limiting examples of suitable enzymes include proteases, cellulases, hemicellulases, peroxidases, lipolytic enzymes (e.g., metallolipolytic enzymes), xylanases, phospholipases, perhydrolases, cutinases, pectinases, pectate lyases, mannanases, keratinases, reductases, oxidases (e.g., choline oxidase), phenoloxidases, lipoxygenases, ligninases, pullulanases, tannases, pentosanases, malanases, beta-glucanases, arabinosidases, hyaluronidases, chondroitinases, laccases, metalloproteinases, amadoriases, glucoamylases, arabinofuranosidases, phytases, isomerases, transferases, nucleases, amylases, or a combination thereof. In some embodiments, a combination of two or more enzymes can be used in the composition. In some embodiments, the two or more enzymes are cellulase and one or more of proteases, hemicellulases, peroxidases, lipolytic enzymes, xylanases, phospholipases, perhydrolases, cutinases, pectinases, pectate lyases, mannanases, keratinases, reductases, oxidases, phenoloxidases, lipoxygenases, ligninases, pullulanases, tannases, pentosanases, malanases, beta-glucanases, arabinosidases, hyaluronidases, chondroitinases, laccases, metalloproteinases, amadoriases, glucoamylases, arabinofuranosidases, phytases, isomerases, transferases, nucleases, amylases, or a combination thereof. One or more of the foregoing enzymes can be comprised in any other composition disclosed herein.

A cellulase can have endocellulase activity (EC 3.2.1.4), exocellulase activity (EC 3.2.1.91), or cellobiase activity (EC 3.2.1.21). A cellulase is an “active cellulase” having activity under suitable conditions for maintaining cellulase activity; it is within the skill of the art to determine such suitable conditions. Besides being able to degrade cellulose, a cellulase in certain embodiments can also degrade cellulose ether derivatives such as carboxymethyl cellulose.

The cellulase may be derived from any microbial source, such as a bacteria or fungus. Chemically-modified cellulases or protein-engineered mutant cellulases are included. Suitable cellulases include, for example, cellulases from the genera Bacillus, Pseudomonas, Streptomyces, Trichoderma, Humicola, Fusarium, Thielavia and Acremonium. As other examples, the cellulase may be derived from Humicola insolens, Myceliophthora thermophile, Fusarium oxysporum, Trichoderma reesei or a combination thereof. The cellulase, such as any of the foregoing, can be in a mature form lacking an N-terminal signal peptide. Commercially available cellulases useful herein include CELLUSOFT®, CELLUCLEAN®, CELLUZYME® and CAREZYME® (Novozymes A/S); CLAZINASE® and PURADAX® HA and REVITALENZ™ (DuPont Industrial Biosciences), BIOTOUCH® (AB Enzymes); and KAC-500(B)® (Kao Corporation).

Alternatively, a cellulase herein may be produced by any means known in the art, for example, a cellulase may be produced recombinantly in a heterologous expression system, such as a microbial or fungal heterologous expression system. Examples of heterologous expression systems include bacterial (e.g., E. coli, Bacillus sp.) and eukaryotic systems. Eukaryotic systems can employ yeast (e.g., Pichia sp., Saccharomyces sp.) or fungal (e.g., Trichoderma sp. such as T. reesei, Aspergillus species such as A. niger) expression systems, for example.

The cellulase in certain embodiments can be thermostable. Cellulase thermostability refers to the ability of the enzyme to retain activity after exposure to an elevated temperature (e.g. about 60-70° C.) for a period of time (e.g., about 30-60 minutes). The thermostability of a cellulase can be measured by its half-life (t½) given in minutes, hours, or days, during which time period half the cellulase activity is lost under defined conditions.

The cellulase in certain embodiments can be stable to a wide range of pH values (e.g. neutral or alkaline pH such as pH of ~7.0 to ~11.0). Such enzymes can remain stable for a predetermined period of time (e.g., at least about 15 min., 30 min., or 1 hour) under such pH conditions.

At least one, two, or more cellulases may be included in the composition. The total amount of cellulase in a composition herein typically is an amount that is suitable for the purpose of using cellulase in the composition (an “effective amount”). For example, an effective amount of cellulase in a composition intended for improving the feel and/or appearance of a cellulose-containing fabric is an amount that produces measurable improvements in the feel of the fabric (e.g., improving fabric smoothness and/or appearance, removing pills and fibrils which tend to reduce fabric appearance sharpness). As another example, an effective amount of cellulase in a fabric stonewashing composition herein is that amount which will provide the desired effect (e.g., to produce a worn and faded look in seams and on fabric panels). The amount of cellulase in a composition herein can also depend on the process parameters in which the composition is employed (e.g., equipment, temperature, time, and the like) and cellulase activity, for example. The effective concentration of cellulase in an aqueous composition in which a fabric is treated can be readily determined by a skilled artisan.

Suitable enzymes are known in the art and can include, for example, MAXATASE®, MAXACAL™, MAXAPEM™, OPTICLEAN®, OPTIMASE®, PROPERASE®, PURAFECT®, PURAFECT® OXP, PURAMAX™, EXCELLASE™, PREFERENZ™ proteases (e.g. P100, P110, P280), EFFECTENZ™ proteases (e.g. P1000, P1050, P2000), EXCELLENZ™ proteases (e.g. P1000), ULTIMASE®, and PURAFAST™ (Genencor); ALCALASE®, SAVINASE®, PRIMASE®, DURAZYM™, POLARZYME®, OVOZYME®, KANNASE®, LIQUANASE®, NEUTRASE®, RELASE® and ESPERASE® (Novozymes); BLAP™ and BLAP™ variants (Henkel Kommanditgesellschaft auf Aktien, Duesseldorf, Germany), and KAP (B. alkalophilus subtilisin; Kao Corp., Tokyo, Japan) proteases; MANNASTAR®, PURABRITE™, and MANNAWAY® mannanases; M1 LIPASE™ LUMA FAST™, and LIPOMAX™ (Genencor); LIPEX®, LIPOLASE® and LIPOLASE® ULTRA (Novozymes); and LIPASE P™ “Amano” (Amano Pharmaceutical Co. Ltd., Japan) lipases; STAINZYME®, STAINZYME PLUS®, NATALASE®, DURAMYL®, TERMAMYL®, TERMAMYL ULTRA®, FUNGAMYL® and BAN™ (Novo Nordisk A/S and Novozymes A/S); RAPIDASE®, POWERASE®, PURASTAR® and PREFERENZ™ (DuPont Industrial Biosciences) amylases; GUARDZYME™ (Novo Nordisk A/S and Novozymes A/S) peroxidases or a combination thereof.

In some embodiments, the enzymes in the composition can be stabilized using conventional stabilizing agents, e.g., a polyol such as propylene glycol or glycerol; a sugar or sugar alcohol; lactic acid; boric acid or a boric acid derivative (e.g., an aromatic borate ester).

A detergent composition herein typically comprises one or more surfactants, wherein the surfactant is selected from nonionic surfactants, anionic surfactants, cationic surfactants, ampholytic surfactants, zwitterionic surfactants, semi-polar nonionic surfactants and mixtures thereof. The surfactant may be petroleum-derived (also referred to as synthetic) or non-petroleum-derived (also referred to as natural). A detergent will usually contain an anionic surfactant such as linear alkylbenzenesulfonate (LAS), alpha-olefinsulfonate (AOS), alkyl sulfate (fatty alcohol sulfate) (AS), alcohol ethoxysulfate (AEOS or AES), secondary alkanesulfonates (SAS), alpha-sulfo fatty acid methyl esters, alkyl- or alkenylsuccinic acid, or soap.

The detergent composition may comprise an alcohol ethoxysulfate of the formula R¹-(OCH₂CH₂)ₓ-O-SO₃M, wherein R¹ is a non-petroleum derived, linear or branched fatty alcohol consisting of even numbered carbon chain lengths of from about C₈ to about C₂₀, and wherein x is from about 0.5 to about 8, and where M is an alkali metal or ammonium cation. The fatty alcohol portion of the alcohol ethoxysulfate (R¹) is derived from a renewable source (e.g., animal or plant derived) rather than geologically derived (e.g., petroleum-derived). Fatty alcohols derived from a renewable source may be referred to as natural fatty alcohols. Natural fatty alcohols have an even number of carbon atoms with a single alcohol (—OH) attached to the terminal carbon. The fatty alcohol portion of the surfactant (R¹) may comprise distributions of even number carbon chains, e.g., C12, C14, C16, C18, and so forth.

In addition, a detergent composition may optionally contain a nonionic surfactant such as alcohol ethoxylate (AEO or AE), carboxylated alcohol ethoxylates, nonylphenol ethoxylate, alkylpolyglycoside, alkyldimethylamineoxide, ethoxylated fatty acid monoethanolamide, fatty acid monoethanolamide, or polyhydroxy alkyl fatty acid amide. The detergent composition may comprise an alcohol ethoxylate of formula R²—(OCH₂CH₂)_{y}— OH, wherein R² is a non-petroleum derived, linear or branched fatty alcohol consisting of even numbered carbon chain lengths of from about C₁₀ to about C₁₈, and wherein y is from about 0.5 to about 15. The fatty alcohol portion of the alcohol ethoxylate (R²) is derived from a renewable source (e.g., animal or plant derived) rather than geologically derived (e.g., petroleum-derived). The fatty alcohol portion of the surfactant (R²) may comprise distributions of even number carbon chains, e.g., C12, C14, C16, C18, and so forth.

The composition can further comprise one or more detergent builders or builder systems. Builders include, for example, the alkali metal, ammonium and/or alkanolammonium salts of polyphosphates, alkali metal silicates, alkaline earth and alkali metal carbonates, aluminosilicates, polycarboxylate compounds, ether hydroxypolycarboxylates, copolymers of maleic anhydride with ethylene or vinyl methyl ether, 1,3,5-trihydroxy benzene-2,4,6-trisulphonic acid, and carboxymethyloxysuccinic acid, the various alkali metal, ammonium and substituted ammonium salts of polyacetic acids such as ethylenediamine tetraacetic acid and nitrilotriacetic acid, as well as polycarboxylates such as mellitic acid, succinic acid, citric acid, oxydisuccinic acid, polymaleic acid, benzene 1,3,5-tricarboxylic acid, carboxymethyloxysuccinic acid, and soluble salts thereof. Examples of a detergent builder or complexing agent include zeolite, diphosphate, triphosphate, phosphonate, citrate, nitrilotriacetic acid (NTA), ethylenediaminetetraacetic acid (EDTA), diethylenetriaminepentaacetic acid (DTMPA), alkyl- or alkenylsuccinic acid, soluble silicates or layered silicates (e.g., SKS-6 from Hoechst). A detergent may also be unbuilt, i.e., essentially free of detergent builder.

The composition can further comprise at least one chelating agent. Suitable chelating agents include, for example, copper, iron and/or manganese chelating agents and mixtures thereof.

The composition can further comprise at least one deposition aid. Suitable deposition aids include, for example, polyethylene glycol, polypropylene glycol, polycarboxylate, soil release polymers such as polytelephthalic acid, clays such as kaolinite, montmorillonite, atapulgite, illite, bentonite, halloysite, or a combination thereof.

The composition can further comprise one or more dye transfer inhibiting agents. Suitable dye transfer inhibiting agents include, for example, polyvinylpyrrolidone polymers, polyamine N-oxide polymers, copolymers of N-vinylpyrrolidone and N-vinylimidazole, polyvinyloxazolidones, polyvinylimidazoles, manganese phthalocyanine, peroxidases, polyvinylpyrrolidone polymers, ethylene-diamine-tetraacetic acid (EDTA); diethylene triamine penta methylene phosphonic acid (DTPMP); hydroxy-ethane diphosphonic acid (HEDP); ethylenediamine N,N′-disuccinic acid (EDDS); methyl glycine diacetic acid (MGDA); diethylene triamine penta acetic acid (DTPA); propylene diamine tetraacetic acid (PDT A); 2-hydroxypyridine-N-oxide (HPNO); or methyl glycine diacetic acid (MGDA); glutamic acid N,N-diacetic acid (N,N-dicarboxymethyl glutamic acid tetrasodium salt (GLDA); nitrilotriacetic acid (NTA); 4,5-dihydroxy-m-benzenedisulfonic acid; citric acid and any salts thereof; N-hydroxyethylethylenediaminetriacetic acid (HEDTA), triethylenetetraaminehexaacetic acid (TTHA), N-hydroxyethyliminodiacetic acid (HEIDA), dihydroxyethylglycine (DHEG), ethylenediaminetetrapropionic acid (EDTP) and derivatives thereof or a combination thereof.

The composition can further comprise silicates. Suitable silicates can include, for example, sodium silicates, sodium disilicate, sodium metasilicate, crystalline phyllosilicates or a combination thereof.

The composition can further comprise dispersants. Suitable water-soluble organic materials can include, for example, homo- or co-polymeric acids or their salts, in which the polycarboxylic acid comprises at least two carboxyl radicals separated from each other by not more than two carbon atoms.

The composition can further comprise one or more other types of polymers in addition to the present poly alpha-1,6-glucan ester compounds. Examples of other types of polymers useful herein include carboxymethyl cellulose (CMC), poly(vinylpyrrolidone) (PVP), polyethylene glycol (PEG), poly(vinyl alcohol) (PVA), polycarboxylates such as polyacrylates, maleic/acrylic acid copolymers and lauryl methacrylate/acrylic acid copolymers.

The composition can further comprise a bleaching system. For example, the bleaching system can comprise an H₂O₂ source such as perborate, percarbonate, perhydrate salts, mono or tetra hydrate sodium salt of perborate, persulfate, perphosphate, persilicate, percarboxylic acids and salts, percarbonic acids and salts, perimidic acids and salts, peroxymonosulfuric acids and salts, sulfonated zinc phthalocyanines, sulfonated aluminum phthalocyanines, xanthene dyes which may be combined with a peracid-forming bleach activator such as, for example, dodecanoyl oxybenzene sulfonate, decanoyl oxybenzene sulfonate, decanoyl oxybenzoic acid or salts thereof, tetraacetylethylenediamine (TAED) or nonanoyloxybenzenesulfonate (NOBS). Alternatively, a bleaching system may comprise peroxyacids (e.g., amide, imide, or sulfone type peroxyacids). In other embodiments, the bleaching system can be an enzymatic bleaching system comprising perhydrolase. Combinations of any of the above may also be used.

The composition can further comprise conventional detergent ingredients such as fabric conditioners, clays, foam boosters, suds suppressors, anti-corrosion agents, soil-suspending agents, anti-soil redeposition agents, dyes, bactericides, tarnish inhibitors, optical brighteners, or perfumes. The pH of a detergent composition herein (measured in aqueous solution at use concentration) can be neutral or alkaline (e.g., pH of about 7.0 to about 11.0).

The composition can be a detergent composition and optionally, a heavy duty (all purpose) laundry detergent composition.

The composition can be a detergent composition, optionally including, for example, a surfactancy boosting polymer consisting of amphiphilic alkoxylated grease cleaning polymers. Suitable amphiphilic alkoxylated grease cleaning polymers can include, for example, alkoxylated polymers having branched hydrophilic and hydrophobic properties, such as alkoxylated polyalkylenimines, random graft polymers comprising a hydrophilic backbone comprising monomers, for example, unsaturated C₁-C₆ carboxylic acids, ethers, alcohols, aldehydes, ketones, esters, sugar units, alkoxy units, maleic anhydride, saturated polyalcohols such as glycerol, and mixtures thereof; and hydrophobic side chain(s), for example, one or more C₄-C₂₅ alkyl groups, polypropylene, polybutylene, vinyl esters of saturated C₁-C₆ mono-carboxylic acids, C₁-C₆ alkyl esters of acrylic or methacrylic acid, and mixtures thereof.

Suitable heavy duty laundry detergent compositions can optionally include additional polymers such as soil release polymers (include anionically end-capped polyesters, for example SRP1, polymers comprising at least one monomer unit selected from saccharide, dicarboxylic acid, polyol and combinations thereof, in random or block configuration, ethylene terephthalate-based polymers and co-polymers thereof in random or block configuration, for example REPEL-O-TEX SF, SF-2 AND SRP6, TEXCARE SRA100, SRA300, SRN100, SRN170, SRN240, SRN300 AND SRN325, MARLOQUEST SL), anti-redeposition polymers, include carboxylate polymers, such as polymers comprising at least one monomer selected from acrylic acid, maleic acid (or maleic anhydride), fumaric acid, itaconic acid, aconitic acid, mesaconic acid, citraconic acid, methylenemalonic acid, and any mixture thereof, vinylpyrrolidone homopolymer, and/or polyethylene glycol, molecular weight in the range of from 500 to 100,000 Daltons (Da); and polymeric carboxylate (such as maleate/acrylate random copolymer or polyacrylate homopolymer).

The heavy duty laundry detergent composition can optionally further include saturated or unsaturated fatty acids, preferably saturated or unsaturated C₁₂-C₂₄ fatty acids; deposition aids, for example, polysaccharides, cellulosic polymers, poly diallyl dimethyl ammonium halides (DADMAC), and co-polymers of DADMAC with vinyl pyrrolidone, acrylamides, imidazoles, imidazolinium halides, and mixtures thereof, in random or block configuration, cationic guar gum, cationic starch, cationic polyacrylamides, or a combination thereof.

The compositions disclosed herein can be in the form of a dishwashing detergent composition. Examples of dishwashing detergents include automatic dishwashing detergents (typically used in dishwasher machines) and hand-washing dish detergents. A dishwashing detergent composition can be in any dry or liquid/aqueous form as disclosed herein, for example. Components that may be included in certain embodiments of a dishwashing detergent composition include, for example, one or more of a phosphate; oxygen- or chlorine-based bleaching agent; non-ionic surfactant; alkaline salt (e.g., metasilicates, alkali metal hydroxides, sodium carbonate); any active enzyme disclosed herein; anti-corrosion agent (e.g., sodium silicate); anti-foaming agent; additives to slow down the removal of glaze and patterns from ceramics; perfume; anti-caking agent (in granular detergent); starch (in tablet-based detergents); gelling agent (in liquid/gel based detergents); and/or sand (powdered detergents).

Additional examples of personal care, household care, and other products and ingredients herein can be any as disclosed in U.S. Pat. No. 8796196, which is incorporated herein by reference. Examples of personal care, household care, and other products and ingredients herein include perfumes, fragrances, air odor-reducing agents, insect repellents and insecticides, bubble-generating agents such as surfactants, pet deodorizers, pet insecticides, pet shampoos, disinfecting agents, hard surface (e.g., floor, tub/shower, sink, toilet bowl, door handle/panel, glass/window) treatment agents (e.g., cleaning, disinfecting, and or coating agents), wipes and other non-woven materials, colorants, preservatives, antioxidants, emulsifiers, emollients, oils, medicaments, flavors, and suspending agents.

In other embodiments, the disclosure relates to a method for treating a substrate, the method comprising the steps:
A) providing a composition comprising a poly alpha-1,6-glucan ester, the alpha-1,6-glucan ester comprising:
   i) poly alpha-1,6-glucan substituted with at least one ester group, wherein the ester group is an aryl ester group, a first acyl group comprising —CO—R″ wherein R″ comprises a chain of 1 to 24 carbon atoms, a second acyl group comprising —CO—Cₓ—COOH, wherein the —Cₓ— portion of the second acyl group comprises a chain of 2 to 24 carbon atoms, or a combination thereof;
   ii) a weight average degree of polymerization of at least 5; and
   iii) a degree of substitution of about 0.001 to about 3.0;
   wherein the poly alpha-1,6-glucan comprises a backbone of glucose monomer units wherein greater than or equal to 40% of the glucose monomer units are linked via alpha-1,6-glycosidic linkages, and optionally at least 5% of the backbone glucose monomer units have branches via alpha-1,2 and/or alpha-1,3 glycosidic linkages;
B) contacting the substrate with the composition; and
C) optionally rinsing the substrate;
wherein the substrate is, for examples, a textile, a fabric, carpet, upholstery, apparel, or a surface. Optionally, the step of contacting the substrate can be performed in the presence of water. The compositions comprising a poly alpha-1,6-glucan ester compound are as disclosed herein.

In one embodiment, the method of treating the substrate can impart anti-greying properties to the substrate, by which is meant that soil which is detached from a fabric during washing of the fabric is suspended in the wash liquor and thus prevented from being redeposited on the fabric. In another embodiment, the method of treating the substrate can impart anti-redeposition properties to a substrate. The effectiveness of anti-greying and anti-redeposition agents can be determined with the use of a tergotometer and multiple washings of pre-soiled fabrics in the presence of initially clean fabrics which act as redeposition monitors, for example using methods known in the art.

In one embodiment, the substrate can be a textile, a fabric, carpet, or apparel. In another embodiment, the substrate can be carpet, upholstery, or a surface. In yet another embodiment, the substrate can be a textile, a fabric, carpet, upholstery, apparel, or a surface. By “upholstery” is meant the soft, padded textile covering that is fixed to furniture such as armchairs and sofas. The treatment provides a benefit to the substrate, for example, one or more of improved fabric hand, improved resistance to soil deposition, improved colorfastness, improved wear resistance, improved wrinkle resistance, improved antifungal activity, improved stain resistance, improved cleaning performance when laundered, improved drying rates, improved dye, pigment or lake update, improved whiteness retention, or a combination thereof. In another embodiment, the substrate can be a surface, for example a wall, a floor, a door, or a panel, or paper, or the substrate can be a surface of an object, such as a table. The treatment provides a benefit to the substrate, for example improved resistance to soil deposition, improved stain resistance, improved cleaning performance, or a combination thereof.

A fabric herein can comprise natural fibers, synthetic fibers, semi-synthetic fibers, or any combination thereof. A semi-synthetic fiber is produced using naturally occurring material that has been chemically derivatized, an example of which is rayon. Non-limiting examples of fabric types herein include fabrics made of (i) cellulosic fibers such as cotton (e.g., broadcloth, canvas, chambray, chenille, chintz, corduroy, cretonne, damask, denim, flannel, gingham, jacquard, knit, matelassé, oxford, percale, poplin, plissé, sateen, seersucker, sheers, terry cloth, twill, velvet), rayon (e.g., viscose, modal, lyocell), linen, and TENCEL®; (ii) proteinaceous fibers such as silk, wool and related mammalian fibers; (iii) synthetic fibers such as polyester, acrylic, nylon, and the like; (iv) long vegetable fibers from jute, flax, ramie, coir, kapok, sisal, henequen, abaca, hemp and sunn; and (v) any combination of a fabric of (i)-(iv). Fabric comprising a combination of fiber types (e.g., natural and synthetic) includes those with both a cotton fiber and polyester, for example. Materials/articles containing one or more fabrics include, for example, clothing, curtains, drapes, upholstery, carpeting, bed linens, bath linens, tablecloths, sleeping bags, tents, car interiors, etc. Other materials comprising natural and/or synthetic fibers include, for example, non-woven fabrics, paddings, paper, and foams. Fabrics are typically of woven or knit construction.

The step of contacting can be performed at a variety of conditions, for example, times, temperatures, wash/rinse volumes. Methods for contacting a fabric or textile substrate, for example, a fabric care method or laundry method are generally well known. For example, a material comprising fabric can be contacted with the disclosed composition: (i) for at least about 5, 10, 20, 30, 40, 50, 60, 70, 80, 90, 100, 110, or 120 minutes; (ii) at a temperature of at least about 10, 15, 20, 25, 30, 35, 40, 45, 50, 55, 60, 65, 70, 75, 80, 85, 90, or 95° C. (e.g., for laundry wash or rinse: a “cold” temperature of about 15-30° C., a “warm” temperature of about 30-50° C., a “hot” temperature of about 50-95° C.); (iii) at a pH of about 2, 3, 4, 5, 6, 7, 8, 9, 10, 11, or 12 (e.g., pH range of about 2-12, or about 3-11); (iv) at a salt (e.g., NaCl) concentration of at least about 0.5, 1.0, 1.5, 2.0, 2.5, 3.0, 3.5, or 4.0% by weight; or any combination of (i)-(iv). The contacting step in a fabric care method or laundry method can comprise any of washing, soaking, and/or rinsing steps, for example. In some embodiments, the rinsing step is a step of rinsing with water.

Other substrates that can be contacted include, for example, surfaces that can be treated with a dish detergent (e.g., automatic dishwashing detergent or hand dish detergent). Examples of such materials include surfaces of dishes, glasses, pots, pans, baking dishes, utensils and flatware made from ceramic material, china, metal, glass, plastic (e.g., polyethylene, polypropylene, and polystyrene) and wood (collectively referred to herein as “tableware”). Examples of conditions (e.g., time, temperature, wash volume) for conducting a dishwashing or tableware washing method are known in the art. In other examples, a tableware article can be contacted with the composition herein under a suitable set of conditions such as any of those disclosed above with regard to contacting a fabric-comprising material.

Certain embodiments of a method of treating a substrate further comprise a drying step, in which a material is dried after being contacted with the composition. The drying step can be performed directly after the contacting step, or following one or more additional steps that might follow the contacting step, for example, drying of a fabric after being rinsed, in water for example, following a wash in an aqueous composition. Drying can be performed by any of several means known in the art, such as air drying at a temperature of at least about 30, 40, 50, 60, 70, 80, 90, 100, 120, 140, 160, 170, 175, 180, or 200° C., for example. A material that has been dried herein typically has less than 3, 2, 1, 0.5, or 0.1 wt% water comprised therein.

In another embodiment, the substrate can be a surface, for example a wall, a floor, a door, or a panel, or the substrate can be a surface of an object, such as a table or dish. The treatment provides a benefit to the substrate, for example improved resistance to soil deposition, improved stain resistance, improved cleaning performance, or a combination thereof. The step of contacting can include wiping or spraying the substrate with the composition.

Non-limiting examples of the embodiments disclosed herein include:

1. A poly alpha-1,6-glucan ester compound comprising: (i) poly alpha-1,6-glucan substituted with at least one ester group selected from an aryl ester group, a first ester group comprising a first acyl group —CO—R″ wherein R″ comprises a chain of 1 to 24 carbon atoms, a second ester group comprising a second acyl group —CO—Cₓ—COOH wherein —Cₓ— comprises a chain of 2 to 24 carbon atoms, or a combination thereof; (ii) a weight average degree of polymerization of at least 5; and (iii) a degree of substitution of about 0.001 to about 3.0; wherein the poly alpha-1,6-glucan comprises a backbone of glucose monomer units wherein greater than or equal to 40% of the glucose monomer units are linked via alpha-1,6 glycosidic linkages, and optionally at least 5% of the backbone glucose monomer units have branches via alpha-1,2 and/or alpha-1,3 glycosidic linkages; optionally wherein the poly alpha-1,6-glucan is (a) only substituted with one or more of the aryl ester group, the first ester group, or the second aryl group, or (b) not substituted with a hydrophilic group.

2. A poly alpha-1,6-glucan ester compound of embodiment 1, wherein at least 5% of the backbone glucose monomer units have branches via alpha-1,2 and/or alpha-1,3 glycosidic linkages.

3. A poly alpha-1,6-glucan ester compound of embodiment 1, wherein at least 5% of the backbone glucose monomer units have branches via alpha-1,2 glycosidic linkages.

4. A poly alpha-1,6-glucan ester compound of embodiment 1, wherein at least 5% of the backbone glucose monomer units have branches via alpha-1,3 glycosidic linkages

5. A poly alpha-1,6-glucan ester compound of embodiment 1, 2, 3, or 4, wherein the degree of substitution is about 0.01 to about 1.5.

6. A poly alpha-1,6-glucan ester compound of embodiment 1, 2, 3, or 4, wherein the degree of substitution is about 0.01 to about 0.6.

7. A poly alpha-1,6-glucan ester compound of embodiment 1, 2, 3, or 4, wherein the degree of substitution is about 0.01 to about 0.2.

8. A poly alpha-1,6-glucan ester compound of embodiment 1, 2, 3, 4, 5, 6, or 7, wherein at least one ester group is an aryl ester group, a first ester group comprising a first acyl group, or a combination thereof.

9. A poly alpha-1,6-glucan ester compound of embodiment 1, 2, 3, 4, 5, 6, 7, or 8, wherein the aryl ester group comprises a benzoyl group or a benzoyl group substituted with at least one halogen, alkyl, halogenated alkyl, ether, cyano, or aldehyde group, or a combination thereof.

10. A poly alpha-1,6-glucan ester compound of embodiment 1, 2, 3, 4, 5, 6, 7, 8, or 9, wherein the aryl ester group comprises a benzoyl group.

11. A poly alpha-1,6-glucan ester compound of embodiment 1, 2, 3, 4, 5, 6, 7, 8, 9, or 10, wherein the first acyl group is an acetyl or a propionyl group.

12. A poly alpha-1,6-glucan ester compound of embodiment 1, 2, 3, 4, 5, 6, 7, 8, 9, 10, or 11, wherein at least one ester group is a first ester group comprising a first acyl group —CO—R″ wherein R″ comprises a chain of 1 to 24 carbon atoms.

13. A poly alpha-1,6-glucan ester compound of embodiment 1, 2, 3, 4, 5, 6, 7, 8, 9, 10, 11, or 12, wherein at least one ester group is a second ester group comprising a second acyl group —CO—Cₓ—COOH wherein —Cₓ— comprises a chain of 2 to 24 carbon atoms.

14. A poly alpha-1,6-glucan ester compound of embodiment 1, 2, 3, 4, 5, 6, 7, 8, 9, 10, 11, 12, or 13, wherein —Cₓ— of the second acyl group further comprises only CH₂ groups.

15. A poly alpha-1,6-glucan ester compound of embodiment 1, 2, 3, 4, 5, 6, 7, 8, 9, 10, 11, 12, 13, or 14, wherein —Cₓ— of the second acyl group further comprises (i) at least one double-bond in the carbon atom chain, and/or (ii) at least one branch comprising an organic group.

16. A poly alpha-1,6-glucan ester compound of embodiment 1, 2, 3, 4, 5, 6, 7, 8, 9, 10, 11, 12, 13, 14, or 15, wherein at least one ester group is a first ester group and at least one ester group is a second ester group.

17. A poly alpha-1,6-glucan ester compound of embodiment 1, 2, 3, 4, 5, 6, 7, 8, 9, 10, 11, 12, 13, 14, 15, or 16, wherein the poly alpha-1,6-glucan ester compound has a weight average degree of polymerization in the range of about 5 to about 4000.

18. A poly alpha-1,6-glucan ester compound of embodiment 1, 2, 3, 4, 5, 6, 7, 8, 9, 10, 11, 12, 13, 14, 15, 16, or 17, wherein the poly alpha-1,6-glucan ester compound has a biodegradability as determined by the Carbon Dioxide Evolution Test Method of at least 10% after 90 days.

19. A composition comprising a poly alpha-1,6-glucan ester compound of embodiment 1, 2, 3, 4, 5, 6, 7, 8, 9, 10, 11, 12, 13, 14, 15, 16, 17, or 18.

20. A composition of embodiment 19, wherein the composition is in the form of a liquid, a gel, a powder, a hydrocolloid, an aqueous solution, a granule, a tablet, a capsule, a bead or pastille, a single compartment sachet, a pad, a multi-compartment sachet, a single compartment pouch, or a multi-compartment pouch.

21. A composition of embodiment 20, further comprising at least one of a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer-inhibiting agent, a chelating agent, a hueing dye, a calcium cation, a magnesium cation, a visual signaling ingredient, an anti-foam, a structurant, a thickener, an anti-caking agent, a starch, sand, a gelling agent, or a combination thereof.

22. A composition of embodiment 21, wherein the enzyme is a cellulase, a protease, a lipase, an amylase, or a combination thereof.

23. A personal care product, a home care product, an industrial product, or a fabric care product comprising a composition of embodiment 19, 20, 21, or 22.

24. A personal care product comprising a poly alpha-1,6-glucan ester compound of embodiment 1, 2, 3, 4, 5, 6, 7, 8, 9, 10, 11, 12, 13, 14, 15, 16, 17, or 18.

25. An industrial product comprising a poly alpha-1,6-glucan ester compound of embodiment 1, 2, 3, 4, 5, 6, 7, 8, 9, 10, 11, 12, 13, 14, 15, 16, 17, or 18.

26. A home care product comprising a poly alpha-1,6-glucan ester compound of embodiment 1, 2, 3, 4, 5, 6, 7, 8, 9, 10, 11, 12, 13, 14, 15, 16, 17, or 18.

27. A product comprising the poly alpha-1,6-glucan ester compound of embodiment 1, 2, 3, 4, 5, 6, 7, 8, 9, 10, 11, 12, 13, 14, 15, 16, 17, or 18, wherein (i) the product further comprises one or more of a perfume, fragrance, flavor, air odor-reducing agent, insect repellent, insecticide, bubble-generating agent, non-woven material, colorant, preservative, antioxidant, emulsifier, emollient, oil, medicament, or suspending agent; and/or (ii) the product is a disinfecting product, cleaning product, coating product, wipe, or hard surface cleaner such as for a floor, countertop, table, desk, tub/shower, sink, toilet bowl, door/cabinet handle/panel, or glass/window.

28. A method for treating a substrate, the method comprising the steps: (a) providing a composition of embodiment 19, 20, 21, 22, 23, 24, 25, 26 or 27; (b) contacting the substrate with the composition; and (c) optionally rinsing the substrate; wherein the substrate is a textile, a fabric, carpet, upholstery, apparel, or a surface.

28. The method of embodiment 27, wherein the substrate is a surface.

Further non-limiting examples of the embodiments disclosed herein include:

1. A composition, such as any as disclosed herein, comprising a poly alpha-1,6-glucan ester compound, wherein, the poly alpha-1,6-glucan ester compound has a degree of polymerization (DPn) in the range of 5 to 1400, and comprising: (i) a poly alpha-1,6-glucan backbone, wherein 40% or more of the glucose monomer units are linked via alpha-1,6-glycosidic linkages, and wherein 0 to 50% of the glucose units of the poly alpha-1,6 glucan backbone further contain branching via alpha-1,2 and/or alpha-1,3 glycosidic linkages; and (ii) one or more ester groups selected from: (a) an aryl ester group, (b) a first acyl group comprising —CO—R″ wherein R″ comprises a chain of 1 to 24 carbon atoms, or (c) a second acyl group comprising -CO-Cx-COOH, wherein the —Cx— portion of the second acyl group comprises a chain of 2 to 24 carbon atoms; wherein the degree of substitution with the one or more ester groups is from about 0.001 to about 1.5; optionally wherein the composition further comprises a detersive surfactant.

2. The composition of embodiment 1, wherein at least 5% of the backbone glucose monomer units have branches via alpha-1,2 and/or alpha-1,3 glycosidic linkages.

3. The composition of embodiment 1, wherein at least 5% of the backbone glucose monomer units have branches via alpha-1,2 glycosidic linkages.

4. The composition of embodiment 1, wherein at least 5% of the backbone glucose monomer units have branches via alpha-1,3 glycosidic linkages

5. The composition of embodiment 1, 2, 3, or 4, wherein the degree of substitution is about 0.01 to about 0.7.

6. The composition of embodiment 1, 2, 3, or 4, wherein the degree of substitution is about 0.01 to about 0.4.

7. The composition of embodiment 1, 2, 3, or 4, wherein the degree of substitution is about 0.01 to about 0.2.

8. The composition of embodiment 1, 2, 3, 4, 5, 6, or 7, wherein each R′ is independently an H, an aryl ester group, or a first acyl group.

9. The composition of embodiment 1, 2, 3, 4, 5, 6, 7, or 8, wherein the aryl ester group comprises a benzoyl group or a benzoyl group substituted with at least one halogen, alkyl, halogenated alkyl, ether, cyano, or aldehyde group, or a combination thereof.

10. The composition of embodiment 1, 2, 3, 4, 5, 6, 7, 8, or 9, wherein the aryl ester group comprises a benzoyl group.

11. The composition of embodiment 1, 2, 3, 4, 5, 6, 7, 8, 9, or 10, wherein the first acyl group is an acetyl, an ethanoyl, or a propionyl group.

12. The composition of embodiment 1, 2, 3, 4, 5, 6, 7, 8, 9, 10, or 11, wherein R′ comprises at least one first acyl group.

13. The composition of embodiment 1, 2, 3, 4, 5, 6, 7, 8, 9, 10, 11, or 12, wherein R′ comprises at least one second acyl group.

14. The composition of embodiment 1, 2, 3, 4, 5, 6, 7, 8, 9, 10, 11, 12, or 13, wherein the —Cx— portion of the second acyl group comprises only CH₂ groups.

15. The composition of embodiment 1, 2, 3, 4, 5, 6, 7, 8, 9, 10, 11, 12, 13, or 14, wherein the —Cx— portion of the second acyl group comprises (i) at least one double-bond in the carbon atom chain, and/or (ii) at least one branch comprising an organic group.

16. The composition of embodiment 1, 2, 3, 4, 5, 6, 7, 8, 9, 10, 11, 12, 13, 14, or 15, wherein R′ comprises at least one first acyl group and at least one second acyl group.

17. The composition of embodiment 1, 2, 3, 4, 5, 6, 7, 8, 9, 10, 11, 12, 13, 14, 15, or 16, wherein the poly alpha-1,6-glucan ester compound has a weight average degree of polymerization in the range of from about 5 to about 1400.

18. The composition of embodiment 1, 2, 3, 4, 5, 6, 7, 8, 9, 10, 11, 12, 13, 14, 15, 16, or 17, wherein the poly alpha-1,6-glucan ester compound has a biodegradability as determined by the Carbon Dioxide Evolution Test Method of at least 10% after 90 days.

19. The composition of embodiment 1, 2, 3, 4, 5, 6, 7, 8, 9, 10, 11, 12, 13, 14, 15, 16, 17, or 18, wherein the composition is in the form of a liquid, a gel, a powder, a hydrocolloid, an aqueous solution, a granule, a tablet, a capsule, a bead or pastille, a single compartment sachet, a multi-compartment sachet, a single compartment pouch, or a multi-compartment pouch.

20. The composition of embodiment 19, further comprising at least one of a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer-inhibiting agent, a chelating agent, a hueing dye, a calcium cation, a magnesium cation, a visual signaling ingredient, an anti-foam, a structurant, a thickener, an anti-caking agent, a starch, sand, a gelling agent, or a combination thereof.

21. The composition of embodiment 20, wherein the enzyme is a cellulase, a protease, a lipase, an amylase, or a combination thereof.

22. A method for treating a substrate, the method comprising the steps: (a) providing a composition of embodiment 1, 2, 3, 4, 5, 6, 7, 8, 9, 10, 11, 12, 13, 14, 15, 16, 17, 18, 19, 20, or 21; (b) contacting the substrate with the composition; and (c) optionally rinsing the substrate; wherein the substrate is a textile, a fabric, carpet, upholstery, apparel, or a surface.

23. The method of embodiment 22, wherein the substrate is a surface.

24. A composition, such as any as disclosed herein, comprising a poly alpha-1,6-glucan ester compound represented by the structure:

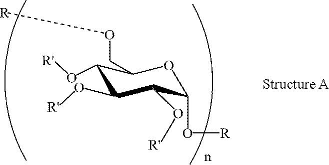

wherein each R′ is independently one or more selected from a list comprising (a) an H, (b) a glucose branching moiety, (c) an aryl ester functional group, (d) a first acyl group comprising —CO—R″ wherein R″ comprises a chain of 1 to 24 carbon atoms, or (e) a second acyl group comprising —CO—Cx—COOH, wherein the —Cx—portion of the second acyl group comprises a chain of 2 to 24 carbon atoms; wherein 40% or more of the glucose monomer units are linked via alpha-1,6 glycosidic linkages, n is at least 5, and 0 to 50% glucose units of the poly alpha-1,6 glucan backbone further contain glucose branching via alpha-1,2 and/or alpha-1,3 glycosidic linkages; wherein the degree of substitution of the poly alpha-1,6-glucan ester compound with the ester group(s) is about 0.001 to about 1.5; optionally wherein the composition further comprises a detersive surfactant.

Further non-limiting examples of the embodiments disclosed herein include:

1. A composition, such as any as disclosed herein, comprising a poly alpha-1,6-glucan ester compound, where the poly alpha-1,6-glucan ester compound comprises:
(i) a poly alpha-1,6-glucan backbone wherein 40% or more of the glucose monomer units are linked via alpha-1,6-glycosidic linkages; and from 0 to 50% glucose units of the poly alpha-1,6 glucan backbone further contains glucose branching moiety linked via alpha-1,2- or alpha-1,3-glycosidic linkages; and
(ii) one or more ester groups selected from:
   (a) an aryl ester group;
   (b) a first acyl group comprising —CO—R″, wherein R″ comprises a chain of 1 to 24 carbon atoms, and
   (c) a second acyl group comprising —CO—Cx—COOH, wherein the —Cx— portion of the second acyl group comprises a chain of 2 to 24 carbon atoms,

wherein the poly alpha-1,6-glucan ester compound has a degree of polymerization (DPn) in the range of 5 to 1400, and
wherein the degree of substitution of ester groups is from about 0.001 to about 1.50.

2. The composition of embodiment 1, wherein at least 5% of glucose units of the poly alpha-1,6-glucan backbone contains branches via alpha-1,2- or alpha-1,3-glycosidic linkages.

3. The composition of any preceding embodiment, wherein the ester group is the aryl ester group or the first acyl group.

4. The composition of embodiment 3, wherein the aryl ester group comprises a benzoyl group or a benzoyl group substituted with at least one halogen, alkyl, halogenated alkyl, ether, cyano, or aldehyde group, or a combination thereof.

5. The composition of embodiment 3, wherein the first acyl group is an acetyl, an ethanoyl, or a propionyl group.

6. The composition of embodiment 3, wherein the aryl ester group comprises a benzoyl group and the first acyl group is an acetyl, an ethanoyl, or a propionyl group.

7. The composition of embodiment 1, wherein the ester group comprises at least one first acyl group.

8. The composition of embodiment 1, wherein the ester group comprises at least one second acyl group.

9. The composition of embodiment 8, wherein the —Cₓ— portion of the second acyl group comprises only CH₂ groups.

10. The composition of embodiment 8, wherein the —Cₓ— portion of the second acyl group comprises:
(i) at least one double-bond in the carbon atom chain, and/or
(ii) at least one branch.

11. The composition of embodiment 1, wherein the ester group comprises at least one first acyl group and at least one second acyl group.

12. The composition of any preceding embodiment, wherein the degree of substitution of ester groups is about 0.01 to about 0.90, preferably about 0.01 to 0.80, more preferably about 0.01 to 0.70.

13. The composition of any preceding embodiment, wherein the poly alpha-1,6-glucan ester compound has a degree of polymerization in the range of from about 5 to about 1200, more preferably from about 10 to 1100, more preferably from about 15 to 1000.

14. The composition of any preceding embodiment, wherein the poly alpha-1,6-glucan ester compound has a biodegradability as determined by the Carbon Dioxide Evolution Test Method of at least 10% on the 90^{th} day.

15. The composition of any preceding embodiment, wherein the composition is in the form of a liquid, a gel, a powder, a hydrocolloid, an aqueous solution, a granule, a tablet, a capsule, a single compartment sachet, a multi-compartment sachet, a single compartment pouch, or a multi-compartment pouch.

16. The composition of any preceding embodiment, wherein the composition further comprising at least one of a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anti-corrosion agent, a soil-suspending agent, an anti-soil re-deposition agent, a dye, a bactericide, a tarnish inhibitor, an optical brightener, a perfume, a saturated or unsaturated fatty acid, a dye transfer inhibiting agent, a chelating agent, a hueing dye, a calcium cation, a magnesium cation, a visual signaling ingredient, an anti-foam, a structurant, a thickener, an anti-caking agent, a starch, sand, a gelling agent, or a combination thereof.

17. The composition of embodiment 16, wherein the enzyme is a cellulase, a protease, an amylase, or a combination thereof.

18. The composition of any preceding embodiment, wherein the composition is a laundry detergent composition.

19. A composition, such as any as disclosed herein, comprising detersive surfactant and a poly alpha-1,6-glucan ester compound represented by the structure:

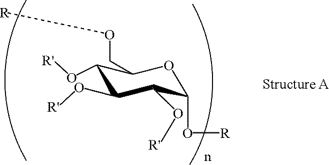

wherein each R′ is independently one or more selected from a list comprising:
(a) a H;
(b) a glucose branching moiety;
(c) an aryl ester functional group;
(d) a first acyl group comprising —CO—R″ wherein R″ comprises a chain of 1 to 24 carbon atoms; and
(e) a second acyl group comprising —CO—Cₓ—COOH, wherein the —Cₓ—portion of the second acyl group comprises a chain of 2 to 24 carbon atoms,
wherein each R is independently one or more selected from a list comprising:
(a) a H;
(b) an aryl ester functional group;
(c) a first acyl group comprising —CO—R″ wherein R″ comprises a chain of 1 to 24 carbon atoms; and
(d) a second acyl group comprising —CO—Cₓ—COOH, wherein the —Cₓ—portion of the second acyl group comprises a chain of 2 to 24 carbon atoms,

wherein 40% or more of the glucose monomer units are linked via alpha-1,6-glycosidic linkages, n is at least 5, and, from 0 to 50% glucose units of the poly alpha-1,6 glucan backbone further contains glucose branching moiety via alpha-1,2- or alpha-1,3-glycosidic linkages,
wherein each glycose branching moiety independently modified by one or more group selected from a list comprising:
   (a) an aryl ester functional group;
   (b) a first acyl group comprising —CO—R″ wherein R″ comprises a chain of 1 to 24 carbon atoms; and
   (c) a second acyl group comprising —CO—Cₓ—COOH, wherein the —Cₓ—portion of the second acyl group comprises a chain of 2 to 24 carbon atoms,
wherein the degree of substitution for ester group of the poly alpha-1,6-glucan ester compound is about 0.001 to about 1.50.

### EXAMPLES

Unless otherwise stated, all ingredients are available from Sigma-Aldrich, St. Louis, Missouri and were used as received.

As used herein, “Comp. Ex.” Means Comparative Example; “Ex.” means Example; “std dev” means standard deviation; “g” means gram(s); “mL” means milliliter(s); “uL” means microliter(s); “wt” means weight; “L” means liter(s); “min” means minute(s); “kDa” means kilodaltons; “PES” means polyethersulfone.

### Method for Determining Anomeric Linkages by NMR Spectroscopy

Glycosidic linkages in water soluble oligosaccharides and polysaccharide products synthesized by a glucosyltransferase GTF8117 and alpha-1,2 branching enzyme were determined by ¹H NMR (Nuclear Magnetic Resonance Spectroscopy). Dry oligosaccharide/polysaccharide polymer (6 mg to 8 mg) was dissolved in a solution of 0.7 mL of 1 mM DSS (4,4-dimethyl-4-silapentane-1-sulfonic acid; NMR reference standard) in D₂O. The sample was stirred at ambient temperature overnight. 525 uL of the clear homogeneous solution was transferred to a 5 mm NMR tube. 2D ¹H,¹³C homo/hetero-nuclear suite of NMR experiments were used to identify AGU (anhydroglucose unit) linkages. The data were collected at 20° C. and processed on a Bruker Avance III NMR spectrometer, operating at either 500 MHz or 600 MHz. The systems are equipped with a proton optimized, helium cooled cryoprobe. The 1D ¹H NMR spectrum was used to quantify glycosidic linkage distribution and finds the polysaccharide backbone as primarily alpha-1,6. The results reflect the ratio of the integrated intensity of a NMR resonance representing an individual linkage type divided by the integrated intensity of the sum of all peaks which represent glucose linkages, multiplied by 100.

### ¹H Nuclear Magnetic Resonance (NMR) Method for Determining Molar Substitution of Poly Alpha-1,6-Glucan Derivatives

Approximately 30 mg of poly alpha-1,6-glucan derivative was weighed into a vial on an analytical balance. The vial was removed from the balance and 1.0 mL of deuterium oxide was added to the vial. A magnetic stir bar was added to the vial and the mixture was stirred to suspend the solid. Deuterated sulfuric acid (50% v/v in D₂O), 1.0 mL, was then added to the vial and the mixture was heated at 90° C. for 1 hour in order to depolymerize and solubilize the polymer. The solution was allowed to cool to room temperature and then a 0.8-mL portion of the solution was transferred into a 5-mm NMR tube using a glass pipet. A quantitative ¹H NMR spectrum was acquired using an Agilent VNMRS 400 MHz NMR spectrometer equipped with a 5-mm Autoswitchable Quad probe. The spectrum was acquired at a spectral frequency of 399.945 MHz, using a spectral window of 6410.3 Hz, an acquisition time of 3.744 seconds, an inter-pulse delay of 10 seconds and 64 pulses. The time domain data were transformed using exponential multiplication of 0.50 Hz.

### Determination of Weight Average Molecular Weight and/or Degree of Polymerization

Degree of polymerization (DP) was determined by size-exclusion chromatography (SEC). For SEC analysis, dry poly alpha-1,6-glucan derivative was dissolved in phosphate-buffered saline (PBS) (0.02-0.2 mg/mL). The chromatographic system used was an Alliance™ 2695 liquid chromatograph from Waters Corporation (Milford, MA) coupled with three on-line detectors: a differential refractometer 410 from Waters, a multi-angle light-scattering photometer Heleos™ 8+ from Wyatt Technologies (Santa Barbara, CA), and a differential capillary viscometer ViscoStar™ from Wyatt Technologies. The columns used for SEC were two Tosoh Haas Bioscience TSK GMPW_{XL} g3K and g4K G3000PW and G4000PW polymeric columns for aqueous polymers. The mobile phase was PBS. The chromatographic conditions used were 30° C. at column and detector compartments, 30° C. at sample and injector compartments, a flow rate of 0.5 mL/min, and injection volume of 100 µL. The software packages used for data reduction were Astra version 6 from Wyatt (triple detection method with column calibration).

### Biodegradation Test Method

The biodegradability of the polysaccharide derivative was determined by the Carbon Dioxide Evolution Test Method (OECD Guideline 301B). In the CO₂ test, inoculated mineral medium was dosed with a known amount of test substance(s) as the nominal sole source of organic carbon and aerated with CO₂-free air. The CO₂ produced from the mineralization of organic carbon within the test chambers was displaced by the flow of CO₂-free air and trapped as K₂CO₃ in KOH trapping solution. The amount of CO₂ produced by the test substance (corrected for that evolved by the blank inoculum) is expressed as a percentage of the theoretical amount of CO₂ (TCO₂) that could have been produced if complete biodegradation of the test substance occurred.

### Method for Evaluating Whiteness Benefit of Polymers (Method A)

Whiteness maintenance, also referred to as whiteness preservation, is the ability of a detergent to keep white items from whiteness loss when they are washed in the presence of soils. White garments can become dirty/dingy looking over time when soils are removed from dirty clothes and suspended in the wash water, then these soils can re-deposit onto clothing, making the clothing less white each time they are washed.

The whiteness benefit of polymers of the present disclosure is evaluated using automatic Tergotometer with 10 pots for laundry formulation testing.

SBL2004 test soil strips supplied by WFK Testgewebe GmbH are used to simulate consumer soil levels (mix of body soil, food, dirt, grass etc.). On average, every 1 SBL2004 strip is loaded with 8 g soil. The SBL2004 test soil strips were cut into 5×5 cm squares for use in the test.

White Fabric swatches of Table 1 below purchased from WFK Testgewebe GmbH are used as whiteness tracers. Before wash test, L, a, b values of all whiteness tracers are measured using Konica Minolta CM-3610D spectrophotometer.

TABLE 1

| Code | Fiber Content | % Fiber Content | Fabric Construction | Size | WFK Code |
|---|---|---|---|---|---|
| CK | Cotton | 100 | Weft Knit | (5 × 5 cm) | 19502_5x5_stamped |
| PC | Polyester/cotton | 65/35 | Weave | (5 × 5 cm) | 19503_5x5_stamped |
| PE | Polyester | 100 | Weft Knit | (5 × 5 cm) | 19508_5x5_stamped |
| PS | Polyester/Spandex | 95/5 | Weft Knit | (5 × 5 cm) | 19507_5x5_stamped |

Additional ballast (background fabric swatches) are also used to simulate a fabric load and provide mechanical energy during the real laundry process. Ballast loads are comprised of cotton and polycotton knit swatches at 5×5 cm size.

4 cycles of wash are needed to complete the test:

Cycle 1: desired amount of base detergent are fully dissolved by mixing with 1L water (at defined hardness) in each Tergotometer port. 60 grams of Whiteness tracers (internal replicate, including 4 types), 21 pieces 5×5 cm SBL2004, and ballast are washed and rinsed in the Tergotometer pot under defined conditions, then dried.

Cycle 2: The whiteness tracers and ballast from each pot are then washed and rinsed again together with a new set of SBL2004 (5×5 cm, 21 pieces) follow the process of cycle 1. All other conditions remain same as cycle 1.

Cycle 3: The whiteness tracers and ballast from each pot are then washed and rinsed again together with a new set of SBL2004 (5×5 cm, 21 pieces) follow the process of cycle 1. All other conditions remain same as cycle 1.

Cycle 4: The whiteness tracers and ballast from each port are then washed and rinsed again together with a new set of SBL2004 (5×5 cm, 21 pieces) follow the process of cycle 1. All other conditions remain same as cycle 1.

After Cycle 4, all whiteness tracers & ballast are tumbled dried between 60-65° C. until dry, the tracers are then measured again using Konica Minolta CM-3610D spectrophotometer. The changes in Whiteness Index (ΔWI(CIE)) are calculated based on L, a, b measure before and after wash.

$$Δ \text{WI} \left(\text{CIE}\right) = \text{WI} \left(\text{CIE}\right) \left(\text{after wash}\right) - \text{WI} \left(\text{CIE}\right) \left(\text{before wash}\right) .$$

### Method for Evaluating Whiteness Performance of Polymers (Method B)

Whiteness maintenance, also referred to as whiteness preservation, is the ability of a detergent to keep white items from whiteness loss when they are washed in the presence of soils. White garments can become dirty/dingy looking over time when soils are removed from dirty clothes and suspended in the wash water, then these soils can re-deposit onto clothing, making the clothing less white each time they are washed. The whiteness benefit of polymers as presently disclosed is evaluated using automatic Miniwasher with 5 pots. SBL2004 test soil stips supplied by WFKTestgewebe GmbH are used to simulate consumer soil levels (mix of body soil, food, dirt, grass etc.). On average, every 1 SBL2004 strip is loaded with 8 g soil. White Fabric swatches of Table 2 below purchased from WFK are used as whiteness tracers. Before wash test, L, a, b values of all whiteness tracers are measured using Konica Minolta CM-3610D spectrophotometer.

TABLE 2

| Code | % Fiber Content | Fiber Construction | Fabric Density (g/m) | Whiteness Index (WI) A* | Whiteness Index (WI) D65** | Size |
|---|---|---|---|---|---|---|
| Cotton Terry | 100 | Woven | ~540 | ~93 | ~163 | 8″×8″ (20 × 20 cm) |
| Cotton Knit | 100 | Weft Knit | ~220 | ~96 | ~165 | 8″x8″ (20 x 20 cm) |
| Polyester/Cotton | 65/35 | Plain Woven | ~125 | ~98 | ~156 | 8″x8″ (20 x 20 cm) |
| Polyester | 100 | Weft Knit | ~200 | ~95 | ~156 | 8″x8″ (20 x 20 cm) |
| Cotton/Spandex | 98/2 | Woven Twill | ~180 | ~86 | ~158 | 8″x8″ (20 x 20 cm) |

Notes:
*WI(A) - illuminant A (indoor lighting)
**WI(D65) - illuminant D65 (outdoor lighting)

Three cycles of wash are needed to complete the test:

Cycle 1: desired amount of base detergent are fully dissolved by mixing with 7.57 L water (at defined hardness) in each Miniwasher tube. 3.5 SBL2004 strips (~28 g of soil) and 3 whiteness tracers (internal replicate) of each fabric type are the washed and rinsed in the Miniwasher under defined conditions, then dried.

Cycle 2: The above whiteness tracers are washed again with new set of SBL2004 sheet, and dried. All other conditions remain same as cycle 1.

Cycle 3: The above whiteness tracers are washed again with new set of SBL2004 sheet, and dried. All other conditions remain same as cycle 1.

After Cycle 3, all whiteness tracers are dried and then measured again using Konica Minolta CM-3610D spectrophotometer. The changes in Whiteness Index (ΔWI(CIE)) are calculated based on L, a, b measure before and after wash.

$$Δ \text{WI} \left(\text{CIE}\right) = \text{WI} \left(\text{CIE}\right) \left(\text{after wash}\right) - \text{WI} \left(\text{CIE}\right) \left(\text{before wash}\right) .$$

Miniwasher have 5 pots, 5 products can be tested in one test. In a typically polymer whiteness performance test, one reference product containing comparative polymer, or no polymer are tested together with 4 products containing inventive polymers, “ΔWI versus reference” is reported.

$$\begin{matrix}Δ \text{WI} \left(\text{CIE}\right) \text{versus reference} = \\ Δ \text{WI} \left(\text{CIE}\right) \left(\text{product}\right) - Δ \text{WI} \left(\text{CIE}\right) \left(\text{reference}\right) .\end{matrix}$$

### Method for Evaluating Cleaning Benefit of Polymers

Cleaning benefit of polymers are evaluated using tergotometer. Some examples test stains suitable for this test are:
Standard Grass ex CFT
Standard Clay ex CFT
ASTM Dust Sebum ex CFT
Highly Discriminating Sebum on polycotton ex CFT
Burnt Bacon on Knitted cotton (prepared using burnt bacon ex Equest)

Dyed Bacon on Knitted Cotton (prepared using dyed bacon ex Equest) The fabrics were analyzed using commercially available DigiEye software for L, a, b values.

Inventive polymer stock solution in de-ionized water is prepared to deliver the desired dosage via 5ml aliquot. To make 1L of test solution, 5ml aliquot of polymer stock solution, and desired amount of base detergent are fully dissolved by mixing with water (at defined hardness) in tergotometer pot. The wash temperature is 20° C.

The fabrics to be washed in each tergotometer pot include 2 pieces of each test stain (2 internal replicates), approximately 3 g of WfK SBL 2004 soil sheets, and additional knitted cotton ballast to make the total fabric weight up to 60 g.

Once all the fabrics are added into tergotometer pot containing wash solution, the wash solution is agitated for 12 minutes. The wash solutions are then drained, and the fabrics are subject to 5 minute rinse steps twice before being drained and spun dry. The washed stains are dried in an airflow cabinet, then analyzed using commercially available DigiEye software for L, a, b values.

This procedure was repeated further three times to give a total of 4 external replicates.

Stain Removal Index (SRI) are calculated from the L, a, b values using the formula shown below. The higher the SRI, the better the stain removal.

$$\text{SRI} = {100}^{*} \left(\left(Δ {\text{E}}_{\text{b}} - Δ {\text{E}}_{\text{a}}\right) / Δ {\text{E}}_{\text{b}}\right)$$

$$Δ {\text{E}}_{\text{b}} = √ \left({\left({\text{L}}_{\text{c}} {\text{-L}}_{\text{b}}\right)}^{2} + {\left({\text{a}}_{\text{c}} {\text{-a}}_{\text{b}}\right)}^{2} + {\left({\text{b}}_{\text{c}} {\text{-b}}_{\text{b}}\right)}^{2}\right)$$

$$Δ {\text{E}}_{\text{a}} = √ \left({\left({\text{L}}_{\text{c}} {\text{-L}}_{\text{a}}\right)}^{2} + {\left({\text{a}}_{\text{c}} {\text{-a}}_{\text{a}}\right)}^{2} + {\left({\text{b}}_{\text{c}} {\text{-b}}_{\text{a}}\right)}^{2}\right)$$

Subscript ‘b’ denotes data for the stain before washing
Subscript ‘a’ denotes data for the stain after washing
Subscript ‘c’ denotes data for the unstained fabric

### Preparation of Poly Alpha-1,6-Glucan Samples

Methods to prepare poly alpha-1,6-glucan containing various amounts of alpha-1,2 branching are disclosed in published patent application WO2017/091533, which is incorporated herein by reference. Reaction parameters such as sucrose concentration, temperature, and pH can be adjusted to provide poly alpha-1,6-glucan having various levels of alpha-1,2-branching and molecular weight. A representative procedure for the preparation of alpha-1,2-branched poly alpha-1,6-glucan is provided below (containing 19% alpha-1,2-branching and 81% alpha-1,6 linkages). The 1D ¹H NMR spectrum was used to quantify glycosidic linkage distribution. Additional samples of poly alpha-1,6-glucan with alpha-1,2-branching were prepared similarly. For example, one sample contained 32% alpha-1,2-branching and 68% alpha-1,6 linkages, and another contained 10% alpha-1,2-branching and 90% alpha-1,6 linkages.

### Preparation of Poly Alpha-1,6-Glucan With 19% Alpha-1,2 Branching

Soluble alpha-1,2-branched poly alpha-1,6-glucan was prepared using stepwise combination of glucosyltransferase GTF8117 and alpha-1,2 branching enzyme GTFJ18T1, according to the following procedure.

A reaction mixture (2 L) comprised of sucrose (450 g/L), GTF8117 (9.4 U/mL), and 50 mM sodium acetate was adjusted to pH 5.5 and stirred at 47° C. Aliquots (0.2 - 1 mL) were withdrawn at predetermined times and quenched by heating at 90° C. for 15 min. The resulting heat-treated aliquots were passed through 0.45-µm filter. The flow-through was analyzed by HPLC to determine the concentration of sucrose, glucose, fructose, leucrose, oligosaccharides and polysaccharides. After 23.5 h, the reaction mixture was heated to 90° C. for 30 minutes. An aliquot of the heat-treated reaction mixture was passed through 0.45-µm filter and the flow-through was analyzed for soluble mono/disaccharides, oligosaccharides, and polysaccharides. A major product was linear dextran with a DPw of 93.

A second reaction mixture was prepared by adding 238.2 g of sucrose and 210 mL of alpha-1,2-branching enzyme GTFJ18T1 (5.0 U/mL) to the leftover heat-treated reaction mixture that was obtained from the GTF8117 reaction described immediately above. The mixture was stirred at 30° C. with a volume of ~ 2.2 L. Aliquots (0.2 - 1 mL) were withdrawn at predetermined times and quenched by heating at 90° C. for 15 min. The resulting heat-treated aliquots were passed through 0.45-µm filter. The flow-through was analyzed by HPLC to determine the concentration of sucrose, glucose, fructose, leucrose, oligosaccharides and polysaccharides. After 95 h, the reaction mixture was heated to 90° C. for 30 minutes. An aliquot of the heat-treated reaction mixture was passed through 0.45-µm filter and the flow-through was analyzed for soluble mono/disaccharides, oligosaccharides, and polysaccharides. Leftover heat-treated mixture was centrifuged using 1 L centrifugation bottles. The supernatant was collected and cleaned more than 200-fold using ultrafiltration system with 1 or 5 KDa MWCO cassettes and deionized water. The cleaned oligo/polysaccharide product solution was dried. Dry sample was then analyzed by ¹H NMR spectroscopy to determine the anomeric linkages of the oligosaccharides and polysaccharides.

### Example 1

### Modification of Poly Alpha-1,6-Glucan With 2-Octen-1-yl Succinic Anhydride

Poly alpha-1,6-glucan powder (15 kDa, 9% alpha-1,2-branching and 91% alpha-1.6 linkages, 10 g) (prepared as described herein above) was dissolved in 15 mL water. To this stirring solution was added 2-octen-1-yl succinic anhydride (3 g). The pH of the mixture was adjusted to pH 9 - 10 with 2.5 wt% NaOH solution. The pH of the reaction was continually adjusted to maintain pH 11 for three hours. The mixture was then neutralized to pH 6.5-7.5. The solution was poured into 100 mL isopropanol to precipitate the polymer. The polymer was collected. This process was repeated two more times. The final polymer was dissolved in water and lyophilized to yield white powder. The degree of substitution was determined by ¹H NMR analysis to be 0.15.

### Example 2

### Modification of Poly Alpha-1,6-Glucan With Benzoic Anhydride

A 4-neck, 250 mL round bottom flask containing a stir rod, thermocouple, addition funnel, and condenser with N₂ inlet on top was charged with a mixture of DMAc (100 mL), CaCl_{2·}2H₂O (4 g), and poly alpha-1,6-glucan (68 kDa, 33% alpha-1,2 branching and 67% alpha 1,6 linkages). The reaction mixture was stirred at 75° C. until a clear solution was formed. Azeotropic distillation was then performed with toluene (25 mL). After that, K₂CO₃ (6 g) and benzoic anhydride (17 g) were added. The reaction mixture was heated with an 88° C. oil bath for 4 hours. Once the reaction reached completion, it was cooled down to room temperature. The desired product was precipitated by isopropanol, washed by isopropanol/water (90/10), and the crude product was further purified through ultrafiltration (MWCO 3 KD) to afford 16 grams of solid. The degree of substitution was determined by ¹H NMR analysis to be 0.1.

### Example 3

### Modification of Poly Alpha-1,6-Glucan With Benzoyl Chloride and Glutaric Anhydride

Poly alpha-1,6-glucan powder (68 kDa, 33% alpha-1,2-branching and 67% alpha-1,6 linkages, 20 gram) was dissolved in DMAc (100 mL) at 80° C. Toluene (25 mL) was added and distilled off to dry the reaction mixture. After that, glutaric anhydride (2.5 gram) and benzoyl chloride (14 gram) were added. The reaction mixture was stirred at 80° C. for 4 h. The product was precipitated and purified using isopropanol. 21 gram of desired material was produced. This product was determined to by ¹H NMR analysis to have DoS (benzoyl) of 0.26 and DoS (glutaroyl) of 0.12.

### Example 4

### Modification of Poly Alpha-1,6-Glucan With Benzoyl Chloride and DMAc

Poly alpha-1,6-glucan powder (68 kDa, 33% alpha-1,2-branching and 67% alpha-1,6 linkages, 20 gram) was dissolved in dimethylacetamide (DMAc, 100 mL) at 80° C. Azeotropic distillation was then performed with toluene (25 mL). After that, benzoyl chloride (17.5 gram) was added. The reaction mixture was stirred at 80° C. for 4 h. The product was precipitated and purified using isopropanol. It was determined by ¹H NMR analysis to have DoS (benzoyl) of 0.79 and DoS (acetyl) of 0.17.

### Example 5

### Modification of Poly Alpha-1,6-Glucan With Benzoyl Chloride

Poly alpha-1,6-glucan powder (68 kDa, 33% alpha-1,2-branching and 67% alpha-1,6 linkages, 20 gram) and CaCl₂·2H₂O (4 gram) were dissolved in DMAc (100 mL) at 80° C. Azeotropic distillation was then performed with toluene (25 mL). After that, K₂CO₃ (6 gram) and benzoyl chloride (17.5 gram) were added. The reaction mixture was stirred at 80° C. for 105 minutes. The product was precipitated and purified using isopropanol. It was determined by ¹H NMR analysis to have DoS (benzoyl) of 0.25.

### Example 6

### Modification of Poly Alpha-1,6-Glucan With Benzoyl Chloride and Acetyl Chloride

Poly alpha-1,6-glucan powder (68 kDa, 33% alpha-1,2-branching and 67% alpha-1,6 linkages, 30 gram) was dissolved in DMAc (150 mL) at 90° C. Azeotropic distillation was then performed with toluene (25 mL). After that, benzoyl chloride (16 gram) and acetyl chloride (3 gram) were added. The reaction mixture was stirred at 90° C. for 2 hrs. The product was precipitated and purified using isopropanol. 28 gram of desired material was produced. It was determined by ¹H NMR analysis to have DoS (benzoyl) of 0.37 and DoS (acetyl) of 0.36.

### Example 7

### Modification of Poly Alpha-1,6-Glucan With Benzoyl Chloride and DMAc

Poly alpha-1,6-glucan powder (56 kDa, 22% alpha-1,2-branching and 78% alpha-1,6 linkages, 20 gram) and CaCl₂·2H₂O (2 gram) were dissolved in DMAc (100 mL) at 90° C. Azeotropic distillation was then performed with toluene (25 mL). After that, benzoyl chloride (17.5 gram) was added. The reaction mixture was stirred at 90° C. for 1 hr. The product was precipitated and purified using isopropanol. It was determined by ¹H NMR analysis to have DoS (benzoyl) of 0.33 and DoS (acetyl) of 0.14.

### Example 8

### Modification of Poly Alpha-1,6-Glucan With Benzoyl Chloride and DMAc

Poly alpha-1,6-glucan powder (60 kDa, 10% alpha-1,2 branching and 90% alpha-1,6 linkages, 20 gram) and CaCl₂·2H₂O (2 gram) were dissolved in DMAc (120 mL) at 90° C. Azeotropic distillation was then performed with toluene (25 mL). After that, benzoyl chloride (15 gram) was added. The reaction mixture was stirred at 90° C. for 2 hrs. The product was precipitated and purified using isopropanol. 23 grams of desired material was produced. It was determined by ¹H NMR analysis to have DoS (benzoyl) of 0.29 and DoS (acetyl) of 0.09.

### Example 9

### Modification of Poly Alpha-1,6-Glucan With Benzoyl Chloride and DMAc

Poly alpha-1,6-glucan (56 kDa, 21% alpha-1,2 branching and 79% alpha-1,6 linkages, 200 gram) was soaked in DMAc (1 L) overnight. The mixture heated to 88° C. DMAc was distilled off under vacuum (~300 mL was removed). To the mixture remaining in the pot was added benzoyl chloride (102 gram) over 10 min. The reaction mixture was stirred for 5-10 minutes, then acetyl chloride (28 gram) was added (over 5-10 min). The reaction mixture was stirred at 88° C. for 1.5 hrs. The reaction mixture was cooled down to room temperature. The crude product was precipitated in isopropanol and washed with isopropanol and dried. It was determined by ¹H NMR analysis to have DoS (benzoyl) of 0.36 and DoS (acetyl) of 0.44.

### Example 10

### Modification of Poly Alpha-1,6-Glucan With 2-Furoyl Chloride

Poly alpha-1,6-glucan powder (56 kDa, 21% alpha-1,2-branching and 79% alpha-1,6 linkages, 20.18 gram) was suspended in DMAc (100 mL) and stirred overnight at room temperature. DMAc (21.81 g) was distilled off at 83° C. and 20 torr followed by the dropwise addition of 2-furanoyl chloride (10.06 g) to the material remaining in the pot. The reaction mixture was stirred at 85° C. for 5 h. The product was precipitated and purified using isopropanol yielding 24.75 g of a light tan powder after vacuum drying. DoS (2-Furoyl): 0.21.

### Example 11

### Modification of Poly Alpha-1,6-Glucan With Benzoyl Chloride and Lauroyl Chloride

Poly alpha-1,6-glucan (56 kDa, 21% alpha-1,2 branching and 79% alpha-1,6 linkages, 120 gram) was soaked in 550 mL DMAc overnight. The mixture was heated to 95° C. DMAc (~185 mL) was distilled away from the mixture under vacuum. Benzoyl chloride (74 gram) and lauroyl chloride (30 gram) were added to the distilled mixture. The resulting reaction was heated for 105 minutes. The product was precipitated in isopropanol and washed with ethyl acetate. After vacuum-drying, 121 gram of solid product was obtained. This product was determined by ¹H-NMR analysis to have a DoS (benzoyl) of 0.42 and DoS (lauroyl) of 0.08.

### Example 12

### Modification of Poly Alpha-1,6-Glucan With 2-Ethylhexanoyl Chloride

DMAc (200 mL) was charged into a 3-neck round-bottom flask equipped with an overhead stirrer and heated to 80° C. under nitrogen. While stirring, oven-dried poly alpha-1,6-glucan (56 kDa, 21% alpha-1,2 branching and 79% alpha-1,6 linkages, 20 gram) was added to the flask portion wise. The mixture was heated at 80° C. for 2 hours. To this was added 2-ethylhexanoyl chloride (10 g), and the mixture was heated at 70° C. for 2 hours. The mixture was then cooled to room temperature and the solvent was removed under vacuum. The product was washed with ether (4 × 50 mL) and dried. This product was determined by ¹H-NMR analysis to have a DoS (benzoyl) of 0.43.

### Example 13

### Biodegradation Test Results

The biodegradability of the polysaccharide derivatives of Examples 5, 6, 7, 8, and 9 was determined by following the OECD 301B Ready Biodegradability CO₂ Evolution Test Guideline. In this study, the test substance is the sole carbon and energy source and, under aerobic conditions, microorganisms metabolize the test substance producing CO₂ or incorporate the carbon into biomass. The amount of CO₂ produced by the test substance (corrected for the CO₂ evolved by blank inoculum) is expressed as a percentage of the theoretical amount of CO₂ (ThCO₂) that could have been produced if the organic carbon in the test substance was completely converted to CO₂.

TABLE 3

Biodegradation Results

| Example | Polysaccharide Ester from | % CO₂ at 12 days |
|---|---|---|
| 13A | Example 5 | 40 |
| 13B | Example 6 | 40 |
| 13C | Example 7 | 50 |
| 13D | Example 8 | 60 |
| 13E | Example 9 | 40 |

These results (Table 3) show the polysaccharide esters have degraded by at least 40% at less than 90 days.

### Example 14

### Polymer Performance in Liquid Base Detergent

Liquid base detergents I and II below are prepared by traditional means known to those of ordinary skill in the art by mixing the listed ingredients:

| | | |
|---|---|---|
| Base Detergent Ingredients | I | II |
| LAS (%) | 8.00 | 8.00 |
| AES (%) | 3.96 | 3.96 |
| NI (%) | 3.83 | 3.83 |
| Amine Oxide (%) | 0.51 | 0.51 |
| 1,2-Propanediol (%) | 0.51 | 0.51 |
| Sodium cumene sulfonate (%) | 2.23 | 2.23 |
| Citric Acid (%) | 2.79 | 2.79 |
| Fatty Acid (%) | 1.73 | 1.73 |
| Ethanol (%) | 0.42 | 0.42 |
| Brightener (%) | 0.046 | 0.046 |
| Glucan ester from Example 9 (%) | 0.00 | 2.00 |
| Enzyme system (%) * | 0.033 | 0.033 |
| Preservative (%) | 0.005 | 0.005 |
| Water | Balance | balance |

*: including Protease, Mannanase, Amylase

The whiteness maintenance of the poly alpha-1,6-glucan ester of Example 9 is evaluated according to the method for evaluating whiteness performance of polymers (method A) by comparing the whiteness performance of formula I and II. As shown in the following table, the glucan ester of Example 9 delivers significant whiteness benefit, especially on synthetic fabric.

| Tracer Fabric | ΔWI(CIE) (I) | ΔWI(CIE) (II) | Delta |
|---|---|---|---|
| PE: 100% Polyester Knit | -22.2 | -2.2 | 20.0 s |

s: data are statistically significant.

Soluble unit dose detergents III and IV below are prepared by traditional means known to those of ordinary skill in the art by mixing the listed ingredients:

| Detergent Ingredients | III | IV |
|---|---|---|
| LAS (%) | 23.73 | 23.73 |
| AES (%) | 11.45 | 11.45 |
| NI (%) | 3.34 | 3.34 |
| Suds Suppressor (%) | 0.10 | 0.10 |
| Glucan ester from Example 9 (%) | 0 | 5.88 |
| DTPA (%) | 0.49 | 0.49 |
| Monoethanolamine (%) | 9.04 | 9.04 |
| 1,2 Propanediol (%) | 8.78 | 8.78 |
| Dipropyleneglycol (%) | 4.33 | 4.33 |
| Sodium Bisulphite (%) | 0.17 | 0.17 |
| Citric Acid (%) | 0.49 | 0.49 |
| Fatty Acid (%) | 6.85 | 6.85 |
| Glycerin (%) | 4.34 | 4.34 |
| Brightener (%) | 0.20 | 0.20 |
| Protease 1 (%) | 0.082 | 0.082 |
| Protease 2 (%) | 0.031 | 0.031 |
| Amylase 1 (%) | 0.005 | 0.005 |
| Amylase 2 (%) | 0.005 | 0.005 |
| Mannanase (%) | 0.004 | 0.004 |
| Preservative (%) | 0.009 | 0.009 |
| Structurant (%) | 0.09 | 0.09 |
| Perfume (%) | 1.89 | 1.89 |
| Dye (%) | 0.013 | 0.013 |
| Water | Balance | Balance |

The whiteness maintenance of the poly alpha-1,6-glucan ester of Example 9 is evaluated according to method for evaluating whiteness performance of polymers (method A) by comparing the whiteness performance of formula III and IV. As shown in the following table, the glucan ester of Example 9 delivers significant whiteness benefit, especially on synthetic fabric.

| Tracer Fabric | ΔWI(CIE) (III) | ΔWI(CIE) (IV) | Delta |
|---|---|---|---|
| PE: 100% Polyester Knit | -40.6 | -4.8 | 35.8 s |
| PS: 95% Polyester/ 5% Spandex Knit | -11.8 | -4.9 | 6.9 s |

s: data are statistically significant.

Liquid base detergents V, VI-a, VI-b, VI-c, VI-d below are prepared by traditional means known to those of ordinary skill in the art by mixing the listed ingredients:

| | Compara tive | Inventive | | | |
|---|---|---|---|---|---|
| Ingredients | V | VI-a | VI-b | VI-c | VI-d |
| AES (%) | 5.78 | 5.78 | 5.78 | 5.78 | 5.78 |
| NI C45EO7 (%) | 6.57 | 6.57 | 6.57 | 6.57 | 6.57 |
| NI C24EO9 (%) | 0.10 | 0.10 | 0.10 | 0.10 | 0.10 |
| LAS (%) | 10.60 | 10.60 | 10.60 | 10.60 | 10.60 |
| DTPA (%) | 0.46 | 0.46 | 0.46 | 0.46 | 0.46 |
| Monoethanolamine (%) | 2.52 | 2.52 | 2.52 | 2.52 | 2.52 |
| Sodium cumene sulfonate (%) | 1.21 | 1.21 | 1.21 | 1.21 | 1.21 |
| NaOH (%) | 0.43 | 0.43 | 0.43 | 0.43 | 0.43 |
| Sodium Tetraborate (%) | 1.21 | 1.21 | 1.21 | 1.21 | 1.21 |
| Citric acid (%) | 1.60 | 1.60 | 1.60 | 1.60 | 1.60 |
| Calcium formate (%) | 0.12 | 0.12 | 0.12 | 0.12 | 0.12 |
| Ethanol (%) | 1.61 | 1.61 | 1.61 | 1.61 | 1.61 |
| Brightener (%) | 0.16 | 0.16 | 0.16 | 0.16 | 0.16 |
| Dye (%) | 0.04 | 0.04 | 0.04 | 0.04 | 0.04 |
| Enzyme (Protease, Amylase, Mannanase) (%) | 0.08 | 0.08 | 0.08 | 0.08 | 0.08 |
| Perfume (%) | 0.57 | 0.57 | 0.57 | 0.57 | 0.57 |
| Antifoam | 0.20 | 0.20 | 0.20 | 0.20 | 0.20 |
| Structurant | 0.10 | 0.10 | 0.10 | 0.10 | 0.10 |
| Glucan ester from Example 5 | 0.00 | 2.65 | 0.00 | 0.00 | 0.00 |
| Glucan ester from Example 7 | 0.00 | 0.00 | 2.65 | 0.00 | 0.00 |
| Glucan ester from Example 9 | 0.00 | 0.00 | 0.00 | 2.65 | 0.00 |
| Glucan ester from Example 10 | 0.00 | 0.00 | 0.00 | 0.00 | 2.65 |
| Water | balance | balan ce | balan ce | balan ce | balan ce |
| ΔWI(CIE) versus reference on PE (100% polyester knit) | reference | 7.10 | 8.48 | 20.08 | 4.18 |

The whiteness maintenance of poly alpha-1,6-glucan esters of Examples 5, 7, 9, and 10 are evaluated according to the method for evaluating whiteness performance of polymers (method B) by comparing the whiteness performance of formula V versus VI-a, VI-b, VI-c and VI-d. The glucan esters of Examples 5, 7, 9 and 10 deliver significant whiteness benefit, especially on synthetic fabric.

Liquid detergents VII and VIII below are prepared by traditional means known to those of ordinary skill in the art by mixing the listed ingredients:

| | | |
|---|---|---|
| Base Detergent Ingredients | VII | VIII |
| LAS (%) | 11.57 | 11.57 |
| AES (%) | 9.71 | 9.71 |
| NI (%) | 5.84 | 5.84 |
| Amine Oxide (%) | 0.98 | 0.98 |
| DTPA (%) | 0.69 | 0.69 |
| NaOH (%) | 1.89 | 1.89 |
| 1,2-Propanediol (%) | 9.59 | 9.59 |
| sodium cumene sulfonate (%) | 0.24 | 0.24 |
| Citric Acid (%) | 3.72 | 3.72 |
| Fatty Acid (%) | 2.95 | 2.95 |
| Brightener (%) | 0.11 | 0.11 |
| Glucan Ester of Example 9 (%) | 0.00 | 1.50 |
| Protease (%) | 0.048 | 0.048 |
| Amylase (%) | 0.006 | 0.006 |
| Mannanase (%) | 0.005 | 0.005 |
| Pectate Lyase (%) | 0.003 | 0.003 |
| Preservative (%) | 0.005 | 0.005 |
| Perfume (%) | 1.40 | 1.40 |
| Structurant (%) | 0.26 | 0.26 |
| Suds Suppresser (%) | 0.003 | 0.003 |
| Dye (%) | 0.005 | 0.005 |
| Water | balance | balance |

The cleaning benefit of the glucan ester of Example 9 is evaluated according to method for evaluating cleaning benefit of polymers by comparing the cleaning performance of formula VII and VIII. As shown in the following table, the glucan ester of Example 9 delivers significant cleaning benefit, especially on greasy stain.

| Stains | SRI (VII) | SRI (VIII) | Delta SRI |
|---|---|---|---|
| Burnt Butter | 61.4 | 70.5 | +9.1 s |

Note: product concentration of the test: 2260 ppm; water hardness: 22 gpg s: data are statistically significant.

What is claimed is:

1. A poly alpha-1,6-glucan ester compound comprising:
(i) poly alpha-1,6-glucan substituted with at least one ester group selected from an aryl ester group, a first ester group comprising a first acyl group —CO—R″ wherein R″ comprises a chain of 1 to 24 carbon atoms, a second ester group comprising a second acyl group —CO—Cₓ—COOH wherein —Cₓ— comprises a chain of 2 to 24 carbon atoms, or a combination thereof;
(ii) a weight average degree of polymerization of at least 5; and
(iii) a degree of substitution of about 0.001 to about 3.0;
wherein the poly alpha-1,6-glucan comprises a backbone of glucose monomer units, and wherein greater than or equal to 40% of the glucose monomer units are linked via alpha-1,6 glycosidic linkages.

2. The ester compound of claim 1, wherein at least 5% of the backbone glucose monomer units have branches via alpha-1,2 and/or alpha-1,3 glycosidic linkages.

3. The ester compound of claim 1, wherein at least one ester group is an aryl ester group, a first ester group comprising a first acyl group, or a combination thereof.

4. The ester compound of claim 3, wherein the aryl ester group comprises a benzoyl group or a benzoyl group substituted with at least one halogen, alkyl, halogenated alkyl, ether, cyano, or aldehyde group, or a combination thereof.

5. The ester compound of claim 3, wherein the first acyl group is an acetyl or a propionyl group.

6. The ester compound of claim 3, wherein the aryl ester group is a benzoyl group and the first acyl group is an acetyl or a propionyl group.

7. The ester compound of claim 1, wherein at least one ester group is a first ester group comprising a first acyl group —CO—R″ wherein R″ comprises a chain of 1 to 24 carbon atoms.

8. The ester compound of claim 1, wherein at least one ester group is a second ester group comprising a second acyl group —CO—Cₓ—COOH wherein —Cₓ—comprises a chain of 2 to 24 carbon atoms.

9. The ester compound of claim 8, wherein —Cₓ— of the second acyl group further comprises only CH₂ groups.

10. The ester compound of claim 8, wherein —Cₓ— of the second acyl group further comprises:
(i) at least one double-bond in the carbon atom chain, and/or
(ii) at least one branch comprising an organic group.

11. The ester compound of claim 1, wherein at least one ester group is a first ester group and at least one ester group is a second ester group.

12. The ester compound of claim 1, wherein the degree of substitution is about 0.01 to about 1.5.

13. The ester compound of claim 1, wherein the degree of substitution is about 0.01 to about 0.6.

14. The ester compound of claim 1, wherein the degree of substitution is about 0.01 to about 0.2.

15. The ester compound of claim 1, wherein the poly alpha-1,6-glucan ester compound has a weight average degree of polymerization in the range of about 5 to about 4000.

16. The ester compound of claim 1, wherein the poly alpha-1,6-glucan ester compound has a biodegradability as determined by the Carbon Dioxide Evolution Test Method of at least 10% after 90 days.

17. A personal care product or an industrial product comprising the poly alpha-1,6-glucan ester compound of claim 1.

18. A composition comprising the poly alpha-1,6-glucan ester compound of claim 1.

19. The composition of claim 18, in the form of a liquid, a gel, a powder, a hydrocolloid, an aqueous solution, a granule, a tablet, a capsule, a bead or pastille, a single compartment sachet, a pad, a multi-compartment sachet, a single compartment pouch, or a multi-compartment pouch.

20. The composition of claim 19, further comprising a surfactant, an enzyme, a detergent builder, a complexing agent, a polymer, a soil release polymer, a surfactancy-boosting polymer, a bleaching agent, a bleach activator, a bleaching catalyst, a fabric conditioner, a clay, a foam booster, a suds suppressor, an anticorrosion agent, a soil-suspending agent, an anti-soil re-deposition agent, a dye, a bactericide, a tarnish inhibitor, an optical brightener, a perfume, a saturated or unsaturated fatty acid, a dye transfer-inhibiting agent, a chelating agent, a hueing dye, a calcium cation, a magnesium cation, a visual signaling ingredient, an antifoam, a structurant, a thickener, an anti-caking agent, a starch, sand, a gelling agent, or a combination thereof.

21. The composition of claim 20, wherein the enzyme is a cellulase, a protease, a lipase, an amylase, or a combination thereof.

22. A personal care product or an industrial product comprising the composition of claim 20.

23. A product comprising the poly alpha-1,6-glucan ester compound of claim 1, wherein
(i) the product further comprises one or more of a perfume, fragrance, flavor, air odor-reducing agent, insect repellent, insecticide, bubble-generating agent, nonwoven material, colorant, preservative, antioxidant, emulsifier, emollient, oil, medicament, or suspending agent; and/or
(ii) the product is a disinfecting product, cleaning product, coating product, wipe, or hard surface cleaner such as for a floor, countertop, table, desk, tub/shower, sink, toilet bowl, door/cabinet handle/panel, or glass/window.

24. A method for treating a substrate, the method comprising the steps:
(a) providing a composition comprising a poly alpha-1,6-glucan ester compound of claim 1;
(b) contacting the substrate with the composition; and
(c) optionally rinsing the substrate;
wherein the substrate is a textile, fabric, carpet, upholstery, apparel, or surface.
